(19) United States
(12) Patent Application Publication
(10) Pub. No.: US 2016/0021862 A1
(43) Pub. Date: Jan. 28, 2016

(54) FISHING PLIERS WITH FISHING LINE RAMP

(71) Applicant: Edson Barton Packer, Heber, UT (US)

(72) Inventor: Edson Barton Packer, Heber, UT (US)

(21) Appl. No.: 14/875,030

(22) Filed: Oct. 5, 2015

Related U.S. Application Data
(63) Continuation-in-part of application No. 13/787,261, filed on Mar. 6, 2013, now Pat. No. 9,161,524.
(60) Provisional application No. 61/665,035, filed on Jun. 27, 2012.

(51) Int. Cl. A01K 97/28; B25B 7/22; A01K 91/04

(52) U.S. Cl. CPC A01K 97/28; A01K 91/04; B25B 7/22

(57) ABSTRACT

Fishing pliers that enable the user to conveniently extend fishing line into the eyelet of a fishing lure, the fishing pliers comprise a pair of opposing first and second elongate members connected at a pivot, the elongate members capable of moving between an open position and a closed position. The first elongate member has an intermediate section that has a magnet and is configured such that an interchangeable modular platform can be mounted thereon with the magnet adjacent a slot of the platform. The interchangeable modular platform is configured to receive fishing line. The magnetized slot is configured to receive an eyelet of a fishing lure. The slot is capable of orienting the eyelet so that line can conveniently enter the eyelet after passing through a channel of the platform.

### CROSS-REFERENCE TO RELATED APPLICATIONS

This application is a continuation-in-part of U.S. patent application Ser. No. 13/787,261, filed Mar. 6, 2013 to Packer, entitled FISHING PLIERS WITH FISHING LINE RAMP, which is incorporated herein by reference, and which claims priority to and the benefit of U.S. Provisional Patent Application Ser. No. 61/665,035, filed Jun. 27, 2012, entitled FISHING PLIERS WITH FISHING LINE RAMP, which is incorporated herein by reference.

### BACKGROUND OF THE INVENTION

1. Field of the Invention

This invention is in the field of fishing pliers.

2. Relevant Technology

Tying fishing line onto a lure, such as a fly, spinner, or bait hook, is often a difficult process, particularly for people with limited fishing experience or eyesight or physical limitations that make tying a small piece of line onto the small eyelet of a lure difficult. The small sizes of line and lure that are desirable for successful fishing often make it difficult to tie the line onto the lure. It is therefore desirable to streamline the tying process by producing products that make the process more efficient and less cumbersome.

### BRIEF SUMMARY

A general object of the present invention is to provide an apparatus and methodology to rapidly thread and tie a fishing fly/hook onto a fishing line and cut excess line in a single continuous process without need to remove gloves or set down the apparatus.

Another object of the present invention is for the apparatus to have a similar function and appearance of hemostat pliers.

Another object of the present invention is to provide the apparatus with gripping jaws having progressively finer gripping surfaces so that the pliers can be used with both large and small objects and facilitate the removal of hooks.

Another object of the present invention is to provide the apparatus with locking jaws to hold miscellaneous fishing and non-fishing related items.

Another object of the present invention is to provide the apparatus with a modular fishing fly/hook positioner and mechanism to facilitate the easy and rapid threading of the fishing line through the eye of the hook.

Another object of the present invention is to provide the apparatus with a device to hold in place both the hook and line following threading to allow the apparatus to be held in a variety of positions without the thread sliding out of the hook or the hook falling from the apparatus.

Another object of the present invention is to provide the apparatus with a set of uniquely designed jaws to facilitate the tying of a variety of knots.

Another object of the present invention is to provide the apparatus with cutters that can be used for many common fishing tasks as well as other tasks.

Another object of the present invention is to provide the apparatus with a magnetic surface to hold fishing flies and hooks.

Another object of the present invention is to provide the apparatus with a needle to clean debris from the eye of the fishing hook.

An additional object of the present invention is to provide the apparatus with suitable materials so it can be used in a harsh environment.

An additional object of the invention is to provide the apparatus with a smooth accurate pivot action.

Another object of the invention is to provide the apparatus with a modular platform that can be interchanged with other platforms to assist in threading an eyelet with different sized line.

As used herein, the term “lure” is used to refer to any object that includes a hook that is designed to be used in angling to catch fish. Examples of lures, as defined in this application, thus include fishing flies, spinners, worm hooks, and a variety of other lures having hooks thereon. Each lure has a hook and an eyelet connected to the hook which is metallic, and is therefore subject to being magnetically coupled to an object through the use of a magnetic force.

The present invention includes a magnet that selectively couples an eyelet to the pliers when the eyelet is placed in close proximity to the portion of the pliers that includes the magnet. The lure can be removed from the magnetized force of the pliers by providing sufficient force to move the lure away from the magnetized lure.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a perspective top view of the pliers 10 in an open position;

FIG. 2 illustrates an enlarged view of the circled portion of the pliers 10 of FIG. 1;

FIG. 2a shows another enlarged view of the intermediate portion of pliers 10;

FIG. 3 illustrates a perspective bottom view of the pliers 10 of FIG. 1, showing the magnet 62 used to magnetically attach a lure to the pliers;

FIG. 4 illustrates a top view of the pliers 10 of FIG. 1, wherein the pliers 10 are closed and have a lure in the form of a fishing fly mounted thereon and magnetically held thereon by the force of the magnet. The metallic eyelet of the lure is mounted in a slot 32 in the pliers 10 and held in the slot by the magnet (until removed by the user), such that a fishing line 30 can be threaded along the channel in the pliers and through the eyelet;

FIG. 5 illustrates the convenient threading of a fishing line along the channel 28 of the pliers 10 of FIG. 1 and through the metallic eyelet of the lure 38 held in place by the magnet of the pliers, such that the magnetic portion of the pliers conveniently holds the lure in place with the eyelet aligned with the channel while the user threads the line along the channel and through the eyelet. The line, extended through the eyelet, is then removed from the pliers;

FIGS. 6-11 illustrate the process of tying a fishing knot using the threaded line of FIG. 5 using the pliers of FIG. 1;

FIG. 6 illustrates placing the pliers of FIG. 1 within the loop 70 of the line;

FIG. 7 illustrates the use of the pliers of FIG. 1 to twist the line in order to begin tying a standard fishing knot;

FIG. 8 illustrates grasping a free end 72 of the twisted line with a pair of distal tips of the pliers of FIG. 1;

FIG. 9 illustrates pulling the free end 72 of the line through the bottom loop of the line;

FIG. 10 illustrates tightening the line to form a desired knot in the line;

FIG. 11 illustrates cutting the excess line from the knot;

FIGS. 12a-15 show another embodiment of pliers 100 of the present invention, FIGS. 12a and 12b showing respective top and bottom perspective views;

FIGS. 13a and 13b show pliers 100 in open top and bottom perspective views;

FIGS. 14a and 14b show pliers 100 in respective top and bottom exploded views;

FIG. 15 shows a close up view of pliers 100;

FIGS. 16-24D show another embodiment of pliers 200 of the present invention;

FIG. 16 illustrates a top perspective view of pliers 200 wherein a modular platform 202 is positioned on the plier body 204 and wherein pliers 200 are in a closed position;

FIG. 17 illustrates pliers 200 of FIG. 16 with modular platform 202 exploded from plier body 204;

FIGS. 18A-B shows pliers 200 of FIGS. 16-17 in respective top and bottom exploded views;

FIGS. 19A-D illustrate a progression of platform 202 (of the pliers of FIGS. 16-18B) above plier body 204 (see FIG. 19A), platform 202 selectively mounted on plier body 204 (see 19B), pliers 200 partially closed (see FIG. 19C), and pliers completely closed (see FIG. 19D) with a lure magnetically coupled to a slot of pliers 200.

FIGS. 20A-F illustrate platform 202 of FIGS. 16-19D.

FIGS. 21A-C illustrate alternative platforms 202A-C having different-sized channels from platform 202, and which are interchangeable with platform 202, such that platforms with different sized channels can be selectively mounted on plier body 204.

FIG. 22 shows a bottom view of the body 212a of first elongate member of the pliers of FIGS. 16-19D;

FIG. 23 shows a bottom view of the body 214a of second elongate member of FIGS. 16-19D;

FIGS. 24A-D illustrate the raised arm 224 of the pliers 200 of FIGS. 16-19D;

FIG. 25 depicts a method of threading and tying a fishing lure using of the pliers of the present disclosure, including pliers 10, 100, and 200, for example.

### DETAILED DESCRIPTION

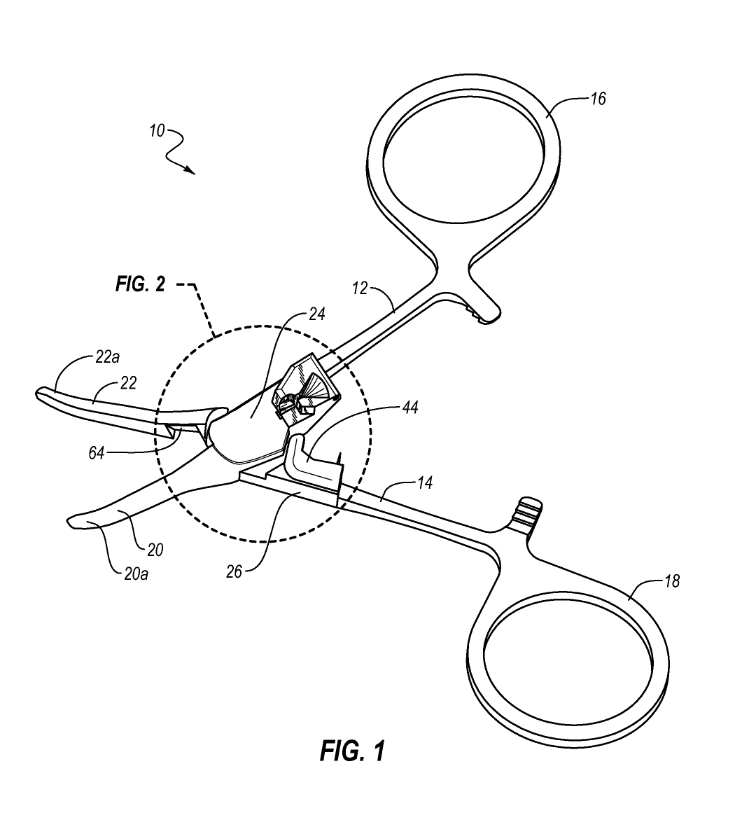

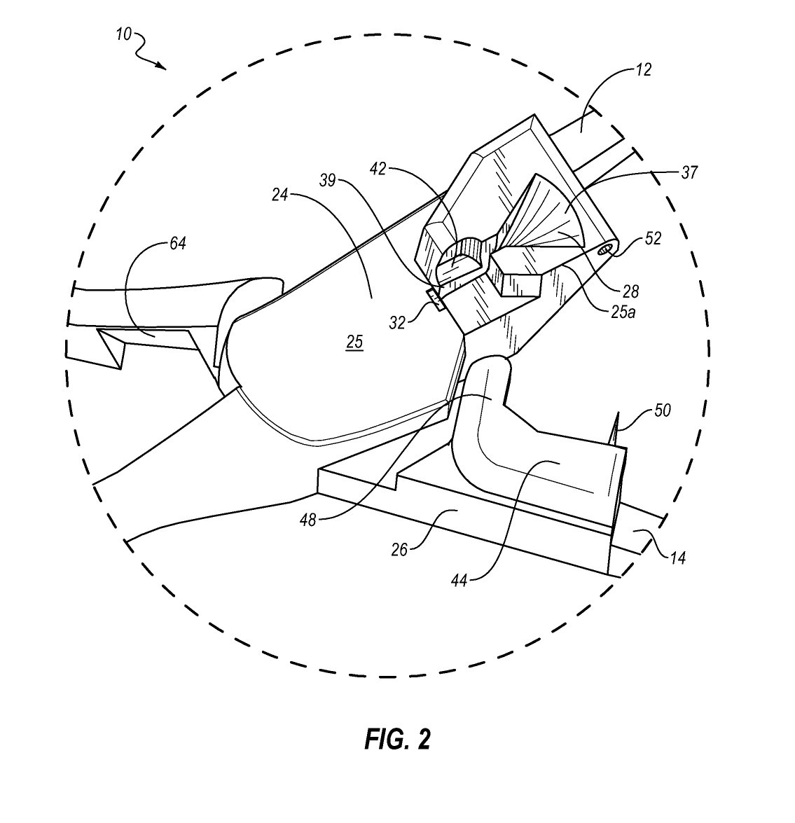

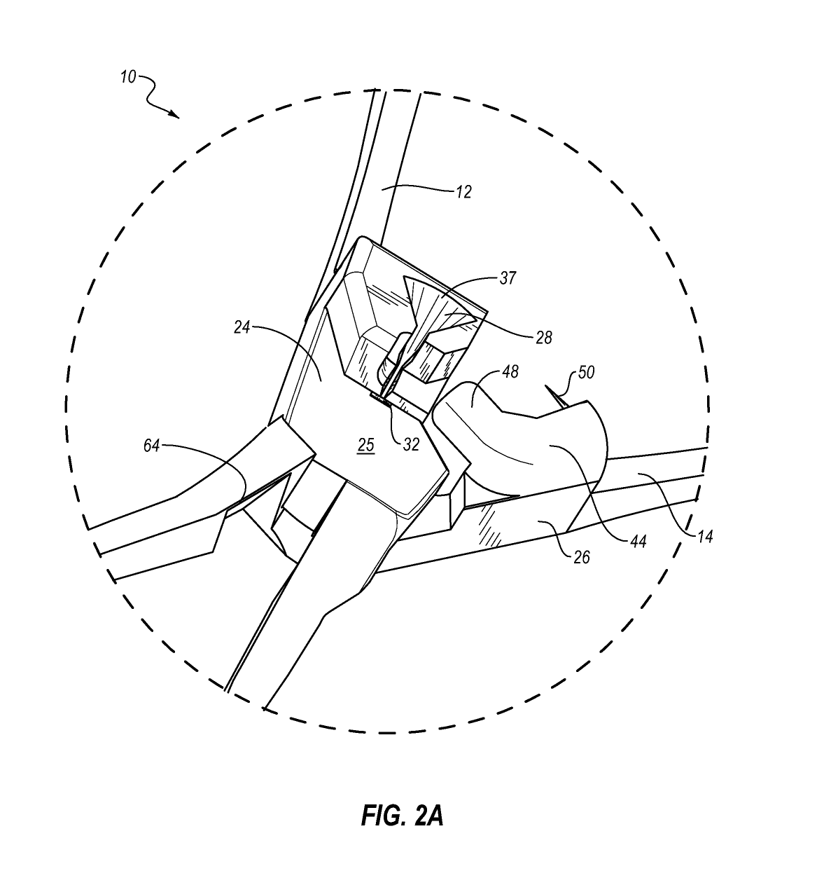

FIG. 1 shows a set of fishing pliers 10, having a first elongate member 12 pivotally connected to a second elongate member 14, each member 12, 14 having a handle 16, 18 at the respective proximal portion thereof and each member having a distal tip 20, 22 at the distal portion thereof. Each member 12, 14 has a respective intermediate section 24, 26 between the proximal handle and the distal tip thereof. FIG. 2 is an enlarged view of a portion of the pliers shown in FIG. 1.

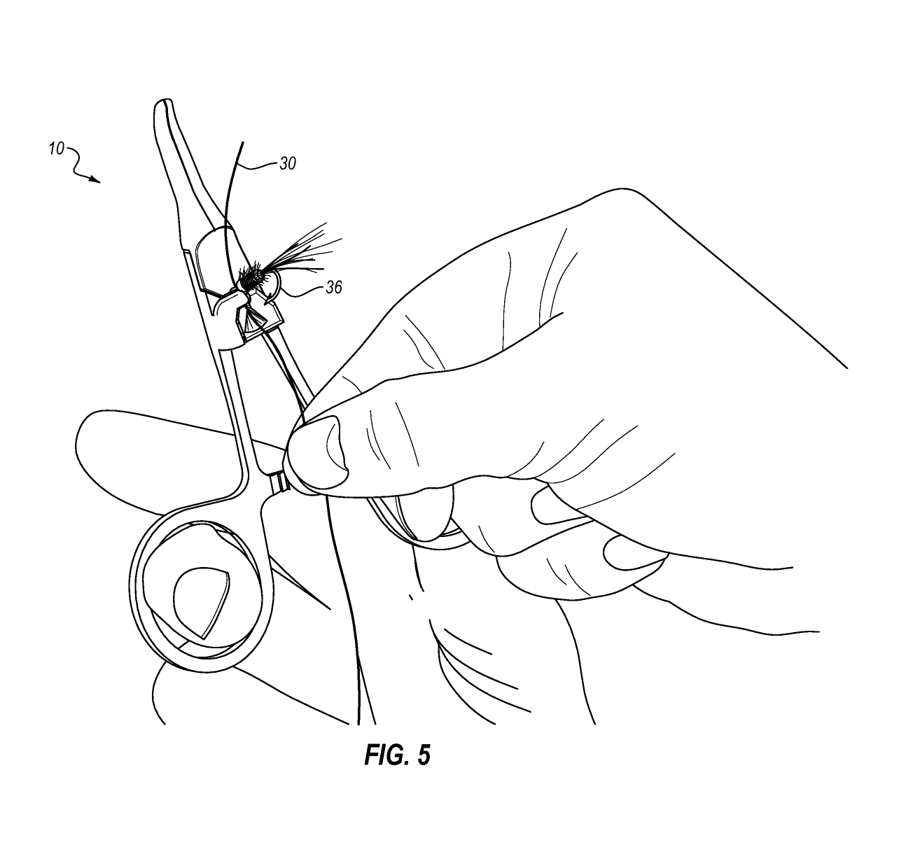

The intermediate section 24 has a distal platform 25 and a proximal raised portion 25a that is adjacent to distal platform 25 and is raised with respect to the distal platform 25. Distal platform 25 can be curved so as to receive the curling fishing line 30 that is extended thereon (see FIG. 5) when a line 30 is placed through an eyelet of a lure.

As shown in FIGS. 1 and 2, the first member 12 of pliers 10 has, in the proximal raised platform 25a thereof, a channel 28 configured to receive a fishing line 30 (see FIG. 5) therein. The distal platform 25 has a slot 32 therein that is generally transverse to the longitudinal axis of channel 28 and is configured to receive the eyelet 36 of a fishing hook 38 of a fishing lure therein.

Pliers 10 are configured to enable a user to conveniently move a fishing line 30 along channel 28 and into the eyelet 36 of a fishing hook that is mounted within slot 32, which is aligned with and adjacent to channel 28 so as to enable the eyelet 36 to conveniently receive line 30, as discussed in detail herein.

A proximal end 37 of the channel 28 is wide, so as to readily receive a fishing line 30. The distal end 39 of the channel is narrow, so as to begin feeding a line into transverse slot 32.

Adjacent channel 28 is a cavity 42 bored out of the raised portion 25a of the intermediate section 24, or otherwise formed in raised portion 25a during manufacture. Second elongate member 14 includes a raised portion 44. When pliers 10 are closed, an arm 48 of the raised portion 44 extends into the cavity 42. In use, the fishing line 30 travels through channel 28 and under arm 48 and then through eyelet 36 mounted in slot 32, which is adjacent to the second channel.

Thus, in the closed position, arm 48 prevents line 30 from being inadvertently moved from channel 28. Arm 48 extends generally transverse to a longitudinal axis of second elongate member 14 and fits into cavity 42 of first elongate member 12 to maintain line 30 in channel 28 during use. In certain embodiments, line 30 can be placed in channel 28, after which arm 48 is placed in cavity 42 over line 30 by closing pliers 10. Optionally, in certain embodiments, line 30 can be placed in channel 28 after arm 42 has already been placed in cavity 48. A spike 50 extends from raised portion 44 and fits into a hole 52 in raised portion 25a when pliers 10 are closed. Spike 50 can be used for cleaning an eyelet 36, for example.

Spike 50 is an example of a protuberance that fits within a mating recess 52 in order to assist with the aligned connection of elongate member 12 to elongate member 14, assuring that the members 12, 14 are properly aligned as line is fed through the channel 28.

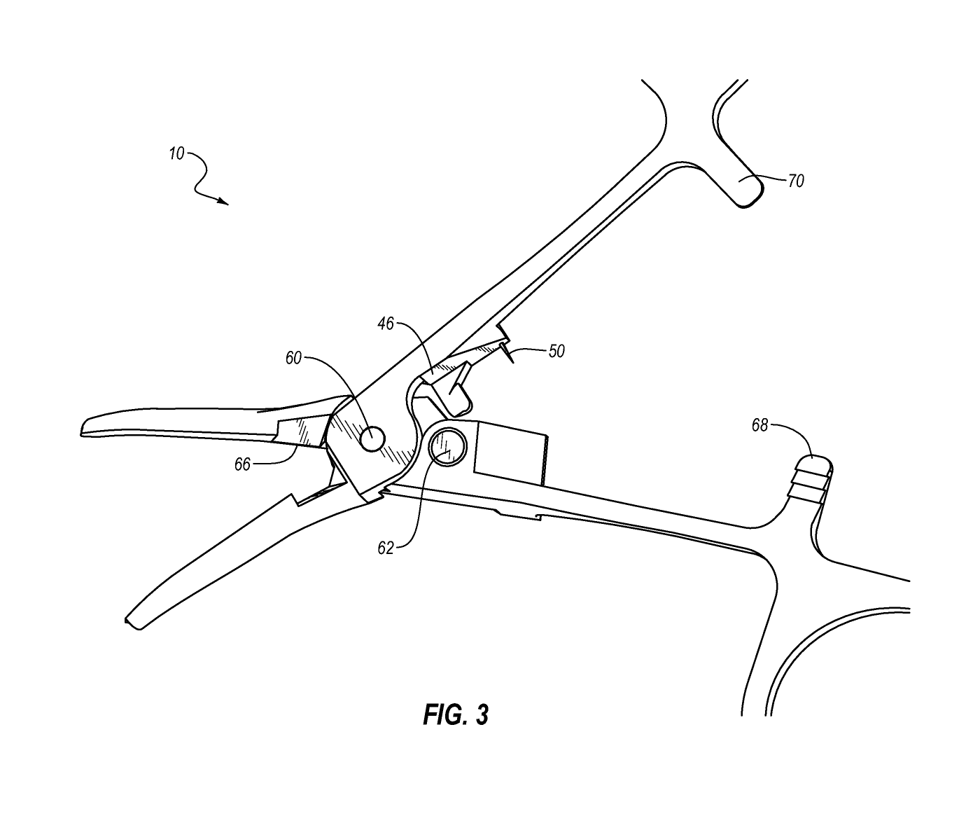

The bottom portion of the pliers shown in FIGS. 1 and 2 is shown in FIG. 3. FIG. 3 shows the pivot point 60 at which the first and second elongate members 12, 14 are connected and further shows a magnet 62 mounted within elongate member 12 below slot 32, the magnet 62 being capable of providing a magnetic force that temporarily maintains the metallic eyelet 36 in the slot 32 while the line 30 is threaded through the eyelet 36.

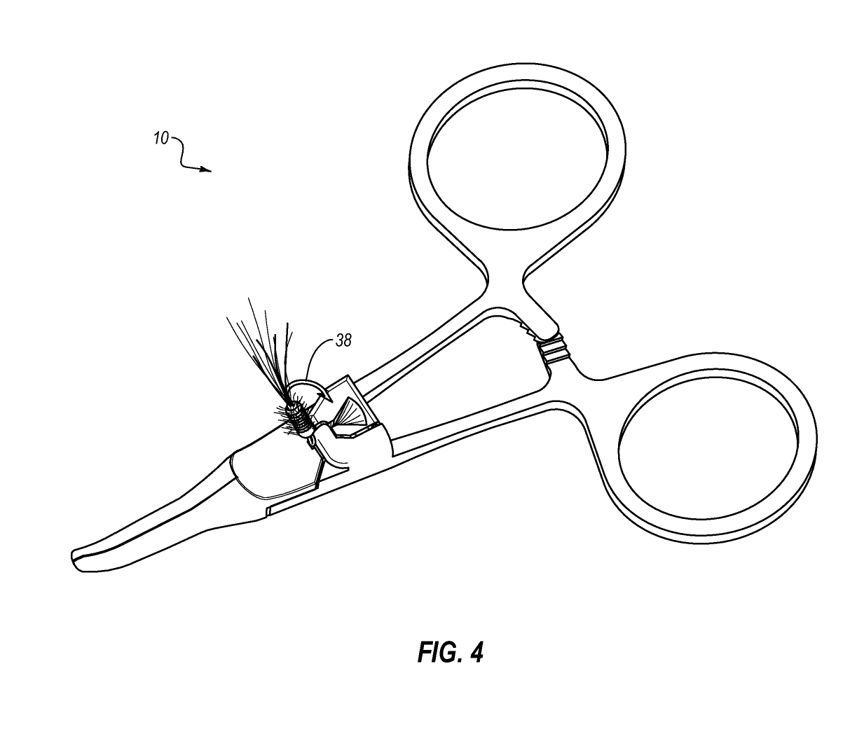

FIG. 4 shows the pliers of FIGS. 1-3 with a fishing lure 38 in the form of a fishing fly magnetically coupled to pliers 10 by being mounted within slot 32 such that the eyelet 36 of the hook of the lure 38 is oriented so as to be capable of receiving fishing line 30 that is extended through channel 28. As shown in FIG. 4, the hole defined by the eyelet is generally transverse to the channel 28. As shown in FIG. 4, pliers 10 are closed such that arm 48 is closed over channel 28, such that line 30 will not be accidentally removed out of channel 28 when placed therein.

FIG. 5 shows a user threading line 30 along channel 28 of the pliers 10 and through eyelet 36 of the hook of lure 38 that is mounted within slot 32 of first elongate member 12. Once pliers 10 are closed, line 30 can be fed through channel 28 and through the eyelet 32 without being accidentally moved out of channel 28.

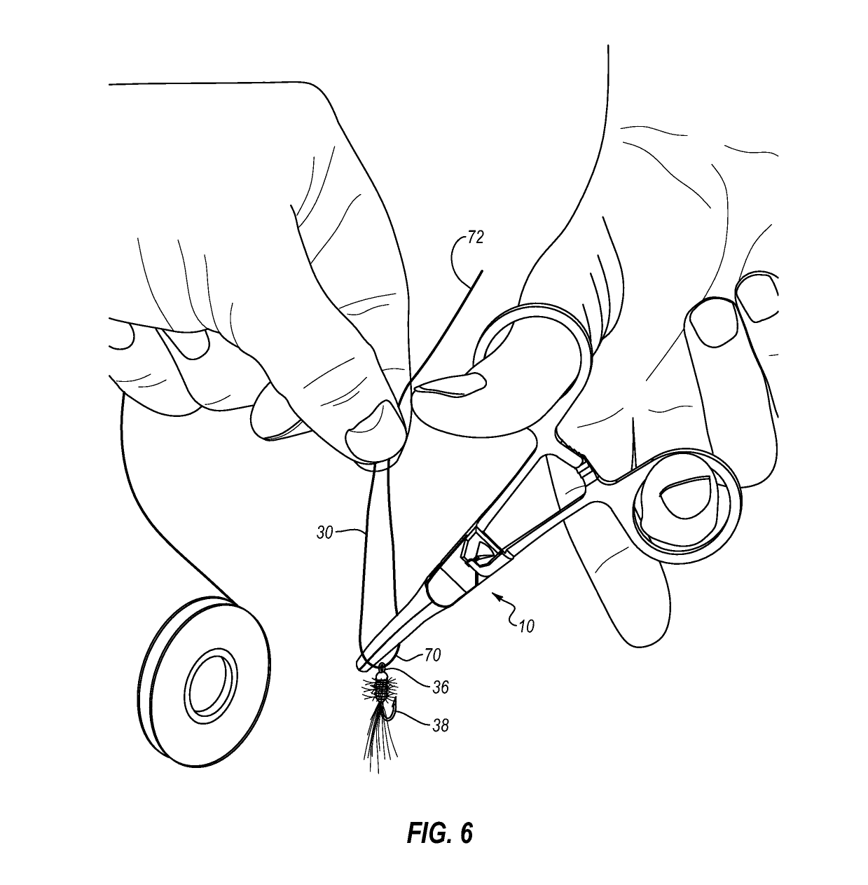

With reference now to FIGS. 6-12, once the line 30 is extended through the eyelet 36 of the hook 38, the pliers can be used to form the desired fishing knot that connects lure 38 to line 30.

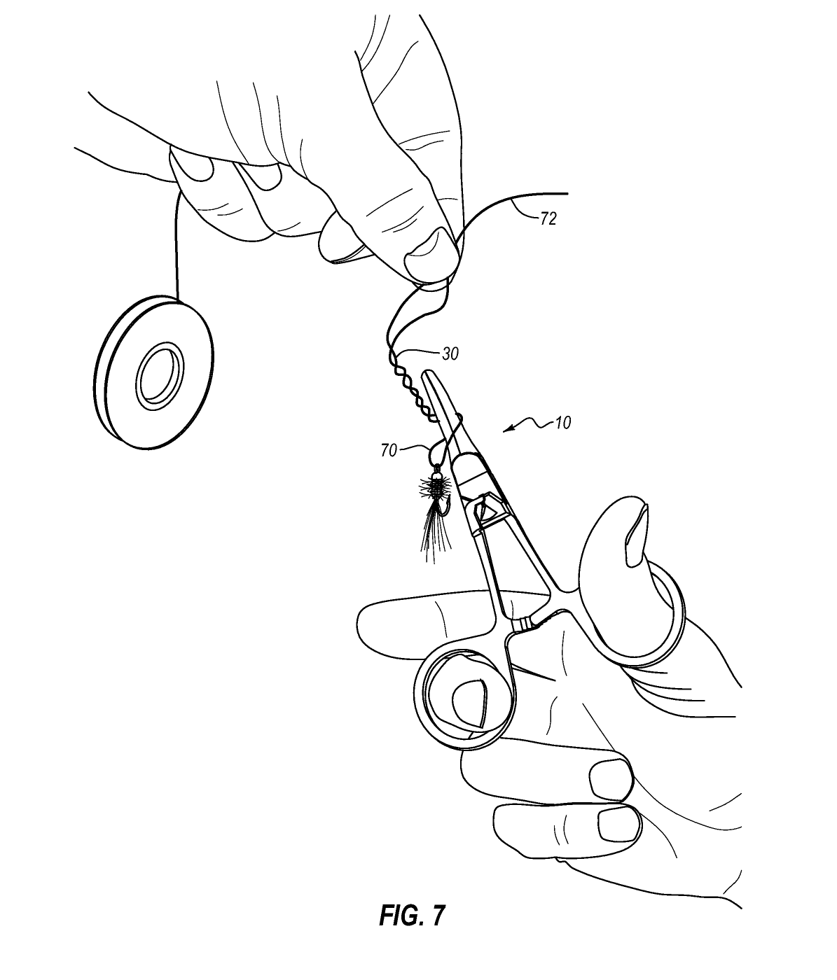

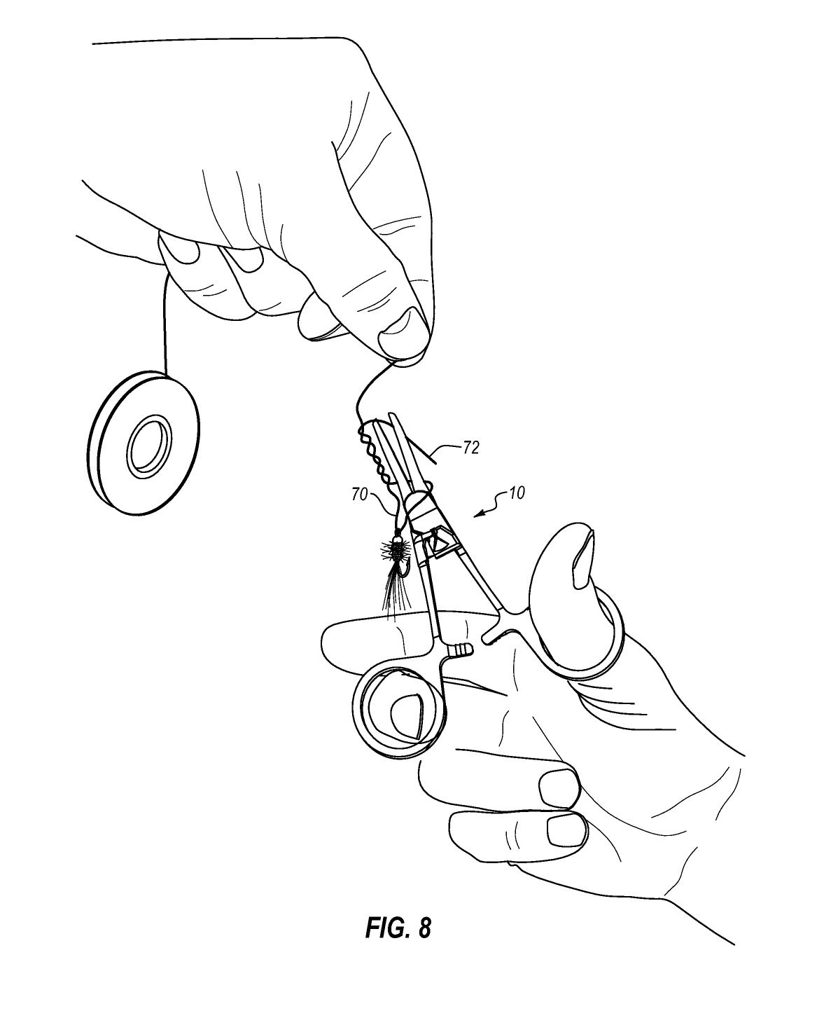

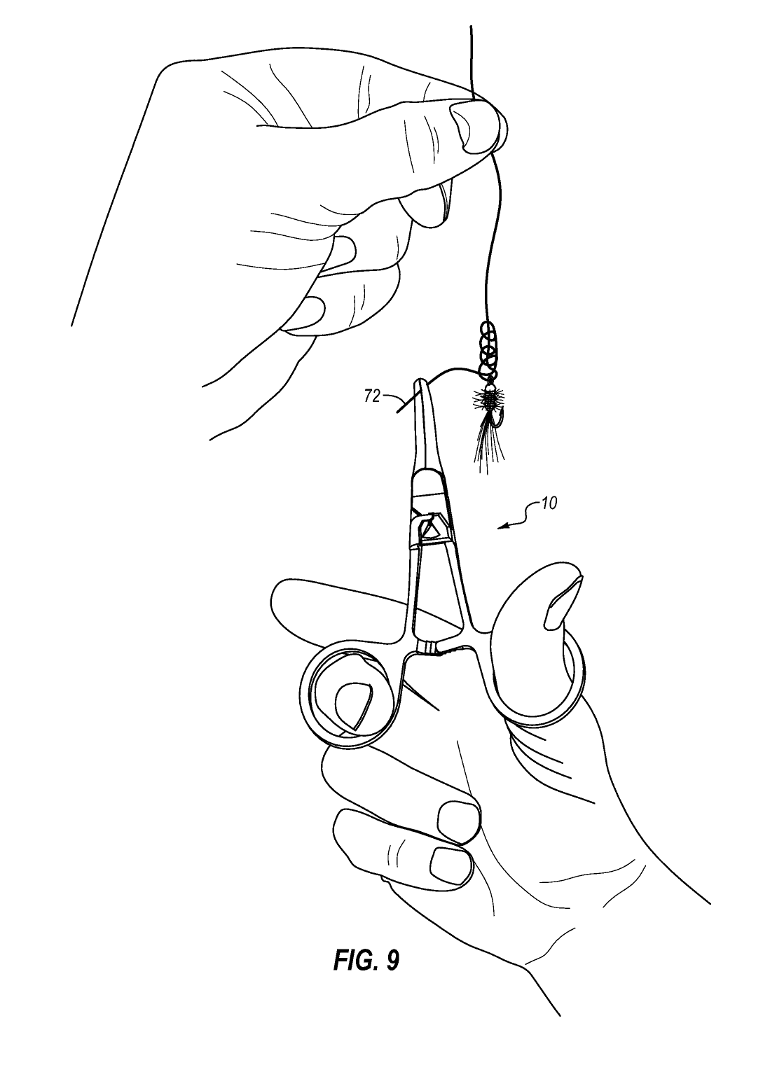

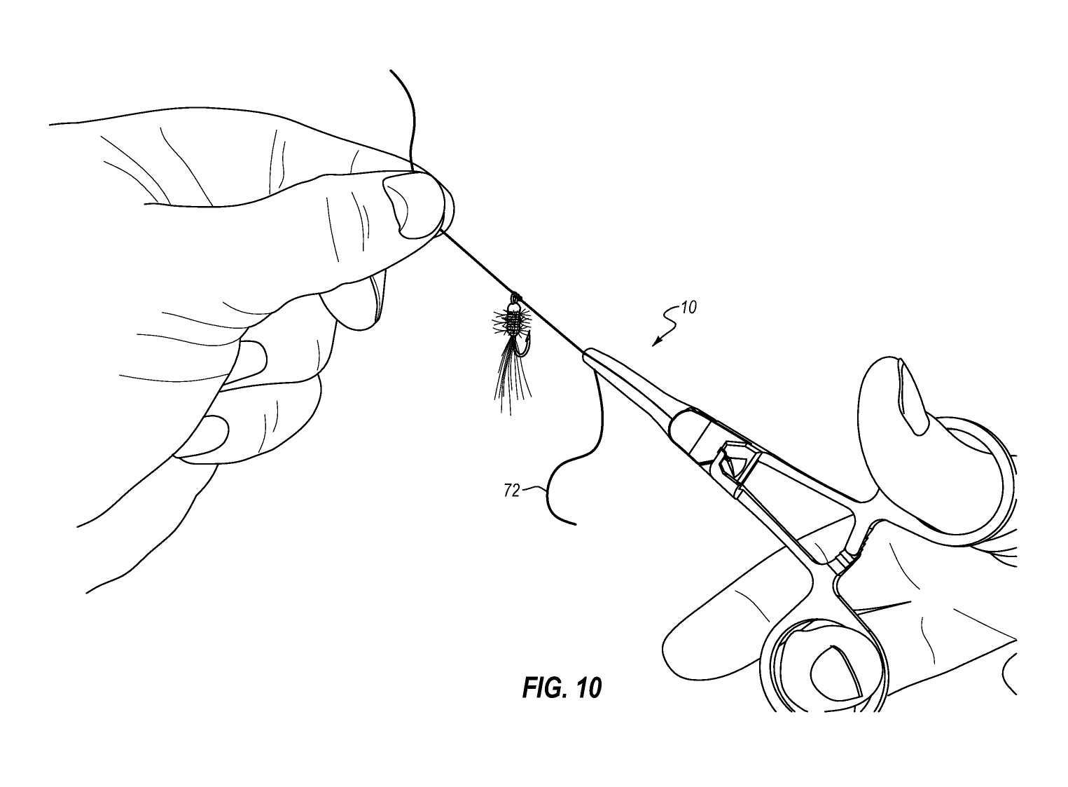

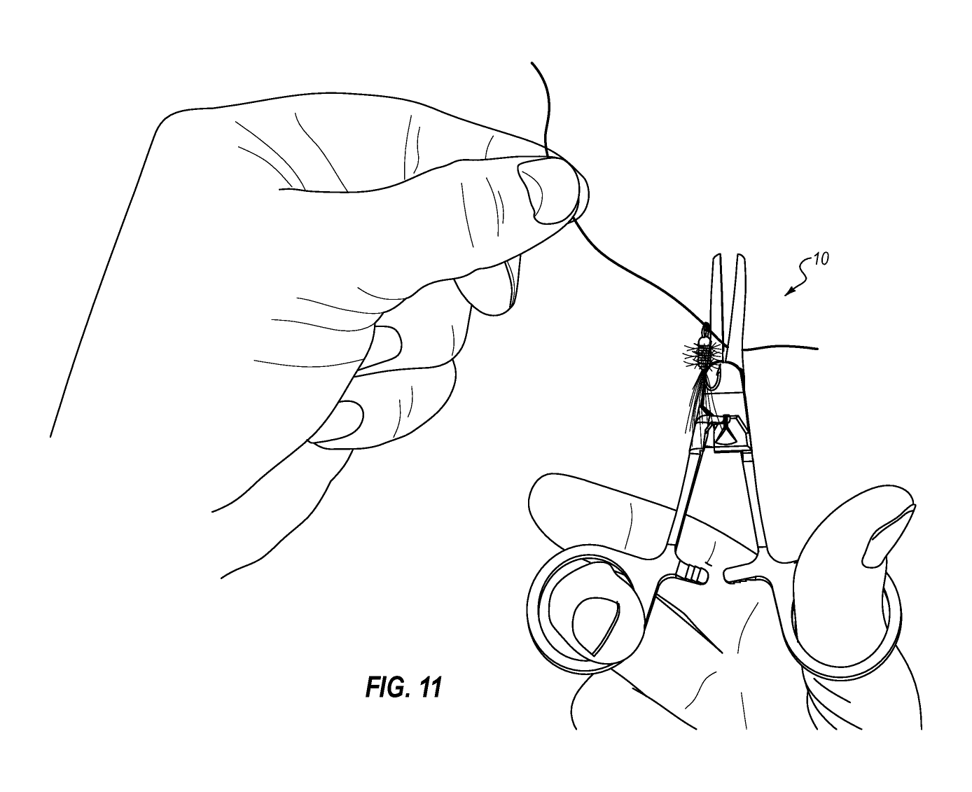

FIG. 6 illustrates placing pliers 10 within the loop 70 of line 30. FIG. 7 illustrates the use of pliers 10 of FIG. 1 to twist line 30 in order to begin tying a standard fishing knot. FIGS. 8-9 illustrate grasping a free end of the twisted line 30 with the distal tip of pliers 10 and pulling the free end 72 of the line 30 through the bottom loop 70 of the line 30. FIG. 10 illustrates tightening the line to form a desired knot in the line. FIG. 11 illustrates cutting the excess line from the knot using cutting blades 64, 66 of pliers 10.

Thus the fishing pliers 10 of the present invention are comprised of first and second members 12, 14 pivotally coupled to each other, each member 12, 14 having handles 16, 18 at proximal ends thereof respectively and distal tip ends 20, 22 at distal ends thereof respectively. The distal tip ends 20, 22 have respective cutting blades 66, 64 at proximal portions thereof, the first elongate member 12 having a channel 28 in the intermediate portion thereof and a slot 32, channel 28 receiving a fishing line 30 when an eyelet 36 of a fishing hook 38 is mounted within the slot 32, and the second elongate member having an arm 48 that fits within a cavity 42 of the first member to close channel 28 such that line 30 is not inadvertently removed from channel 28 during attachment. The fishing pliers 10 are very versatile and can accomplish a number of different tasks required by the fisherman to connect a fishing hook or fly or other lure to a fishing line, which is often a cumbersome and time consuming process, which becomes more difficult with age or disability. Pliers 10 are used to initially thread the line 30 onto the hook 38, and then to form a knot in the line and cut away excess line from the knot once the hook is threaded.

Magnet 62 is positioned in elongate member 12 adjacent slot 32 such that the magnetic force of the magnet retains the eyelet 30 of the hook therein such that line 30 can be readily passed through the eyelet 30. Elongate members 12, 14 may comprise a material such as plastic or stainless steel, for example. In one embodiment, proximal raised portion 25a is manufactured as a separate snap in piece for convenient manufacturing and/or for enabling the changing of the size of the chamber 28 for receiving different line diameters, etc.

With reference again to FIG. 1, the distal tips 20, 22 of the respective elongate members of the pliers of the present invention are substantially straight along the surfaces of the respective bodies thereof and have a slight bend at the distal tip end 20a, 22a thereof. However, in other embodiments, the slight bend at the tip end is not required.

The bodies of distal tips 20, 22 are substantially straight with little or no tapering angle along the surfaces of the bodies thereof (and do not substantially bend until reaching the tip ends 20a, 22a) in order to improve the ability to twist fishing line 30 without fishing line 30 falling off the distal tips 20, 22, as shown in FIG. 7. The straight or substantially straight tips, e.g., tips 20, 22 make twisting the line 30 during a knot tying procedure, as shown in FIG. 7 more convenient because the line 30 is less likely to fall off the pliers, as opposed to dramatically tapering tips. Dramatically tapering tips have a surface angle that causes line to fall off during the twisting procedure. However, the straight or substantially straight tips 20, 22 make twisting the line 30 during a knot tying procedure, as shown in FIG. 7 more convenient because the line is less likely to fall off.

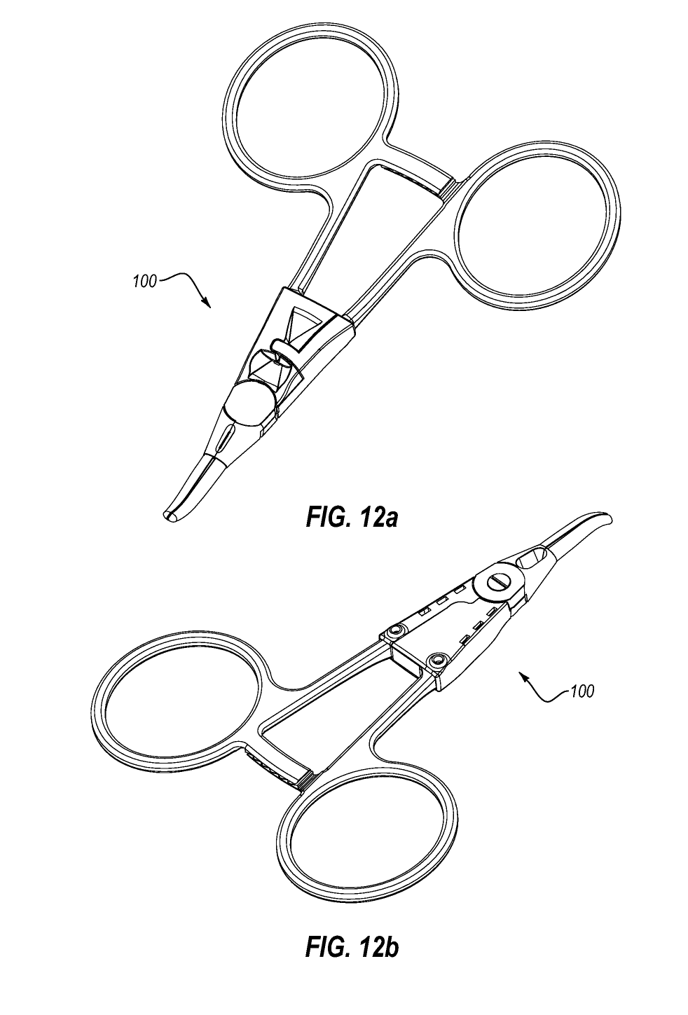

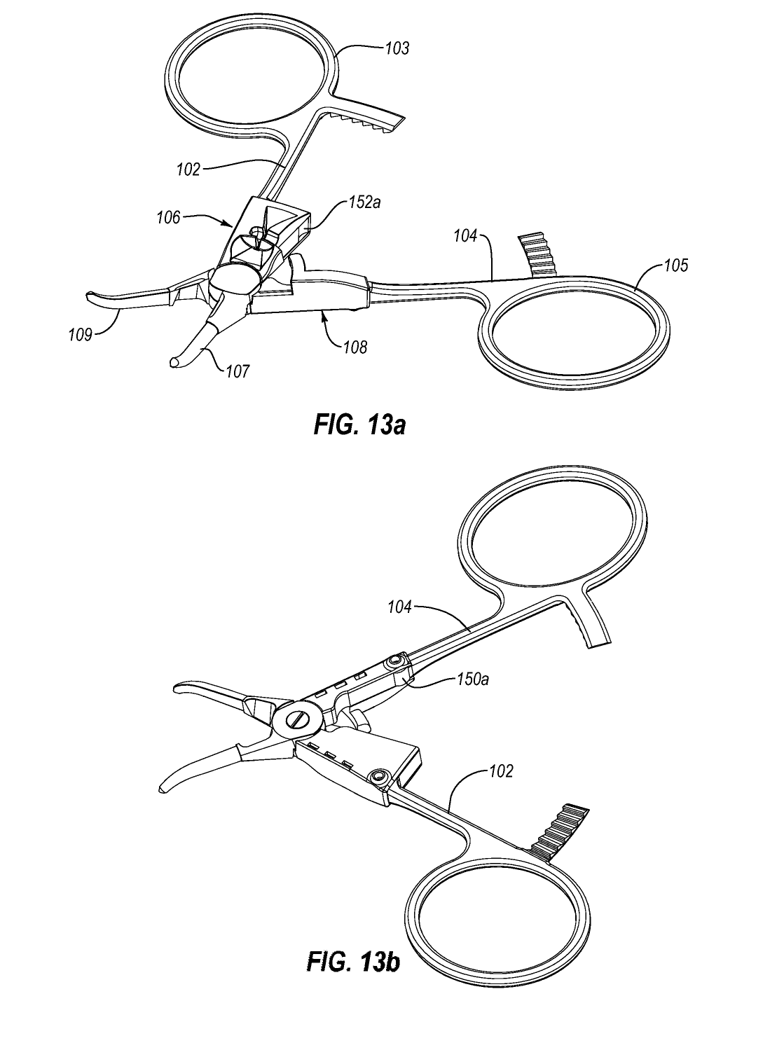

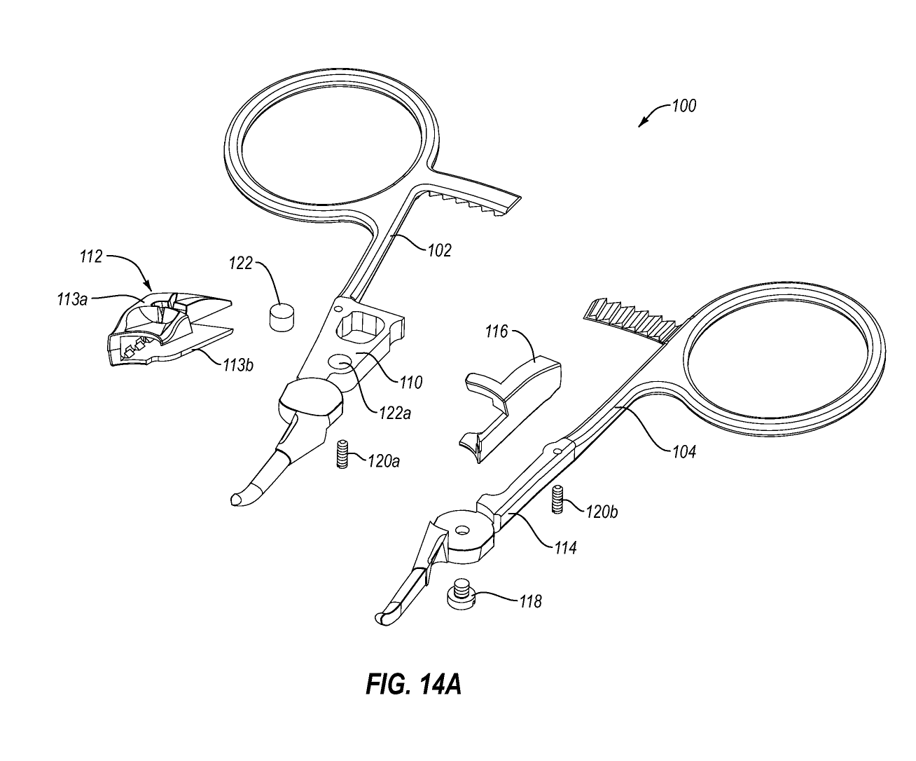

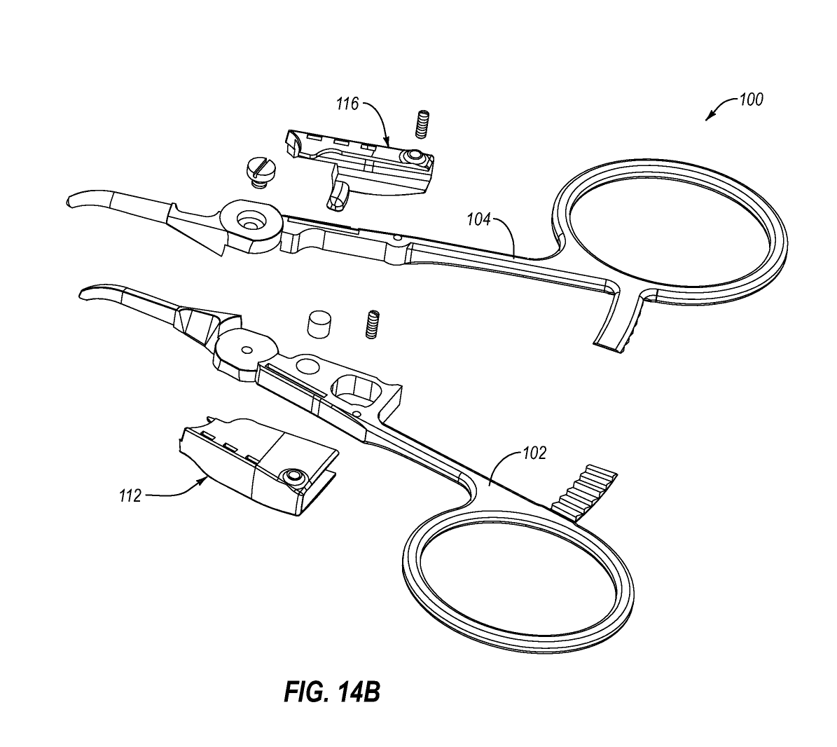

FIGS. 12a-15 show another embodiment of pliers 100 of the present invention. FIGS. 12a and 12b show respective top and bottom perspective views in a closed position. FIGS. 13a and 13b show respective top and bottom views of pliers 100 in an open position. Pliers 100 are similar to pliers 10, and, as shown in FIGS. 14a-b and 15, are assembled through the use of an attachable platform assembly and arm assembly components in the intermediate sections thereof.

Pliers 100 comprise a first elongate member 102 and a second elongate member 104, each having a handle 103, 105 at the respective proximal portion thereof and a distal tip 107, 109 at the distal portion thereof, and each having a respective intermediate section 106, 108 between the proximal handle and distal tip thereof.

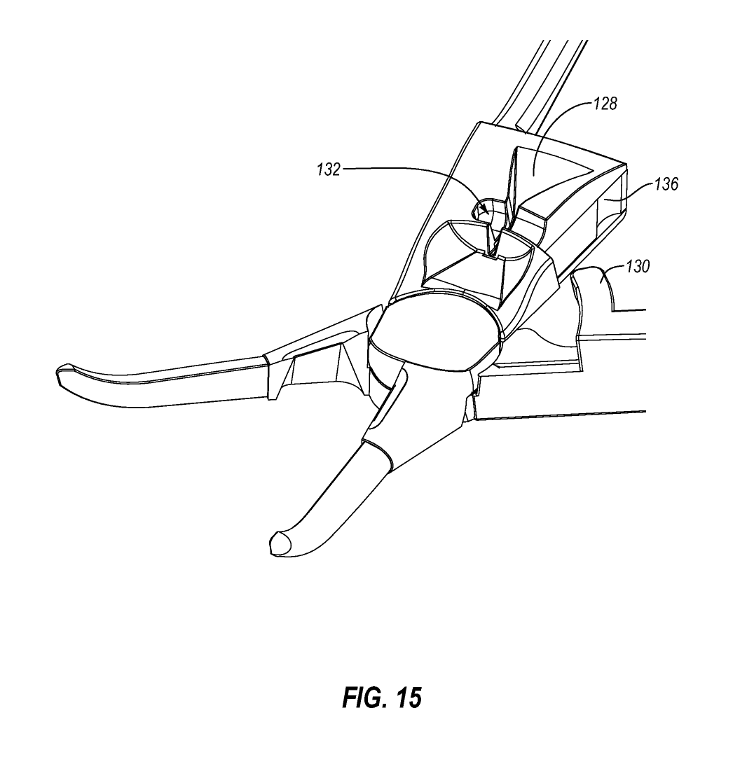

With reference to FIGS. 13a, 14a-b and FIG. 15, the intermediate section 106 of elongate member 102 comprises: (i) a frame portion 110 between the proximal handle and the distal tip; and (ii) an attachable platform assembly 112 that is slidably mounted onto the frame portion 110 during assembly and attached thereto with screw 120a. Platform assembly 112 comprises (A) a proximal raised portion 113a containing the channel 128 for feeding fishing line into an eyelet of a fishing lure; and (B) a lower attachment panel 113b coupled thereto, forming U-shaped slidably mounting assembly 112.

Intermediate section 108 of elongate member 104 comprises: (i) a frame portion 114 between the proximal handle and the distal tip and (ii) an attachable arm assembly 116 that is mounted onto the frame portion 114 during assembly and attached thereto with screw 120b. Screw 118 rotatably couples first elongate member 102 to second elongate member 104. Magnet 122 mounts into aperture 122a of intermediate section 110 between portions 113a and 113b of assembly 112. Magnet 122 may be retained in a position between portions of assembly 112 and/or through the use of an adhesive or press fitting relationship within frame 110, for example.

In one embodiment platform assembly 112 and arm assembly 116 are attachable and detachable from respective frame portions 110, 114, and are thus modular pieces which can be exchanged for assemblies having different sized components.

Platform assembly 112 has channel 128 therein for feeding fishing line into an eyelet of a lure. A slot for holding an eyelet adjacent magnet 122 is transverse to channel 128. Channel 128 of assembly 112 may be the same as or similar to channel 28 of pliers 10, for example, such that pliers 10 can function similarly to pliers 110.

In one embodiment, platform assembly 112 and arm assembly 116 are attachable and detachable from respective frame portions 110, 114, and are thus modular pieces which can be exchanged for assemblies having different sized components. Thus, different types and sizes of assembly 112 and assembly 116, having different sized channel 128 and arm 130, respectively, for different sized fishing line, for example, can be used on respective elongate members 102, 104. Since such pieces can be modular, one size of assembly 112 and/or assembly 116 may be substituted for another into order to feed different sized line through different sized eyelets using the same first and second members 102, 104.

In addition, the manufacture of separate, attachable platform assembly 112 and arm assembly 116 enables pliers 100 to weigh less. Additional benefits are that the components may be easily machined, and may be used with different sized eyelets and fishing lines, depending upon the sizes of the channels in the platform assembly 112. Assembly 112 and/or assembly 116 may be made of plastic, for example, while the first and second members 102, 104 may be made of a metallic material, for example, such as stainless steel, enabling the detailed portions of assembly 112 and assembly 116 to be very accurately and inexpensively produced.

Arm 130 of arm assembly 116 fits within cavity 132 when elongate members 102, 104 are in a closed position, thereby assisting with proper alignment, retaining the line within the channel 128 of assembly 112 and providing a guide against which the lure can be placed.

Tab 150a fits within a mating recess in the form of groove 152a. Tab 150a is another example of a protuberance that fits within a mating recess in order to assist with the aligned connection of elongate member 102 to elongate member 104, assuring that the members 102, 104 are properly aligned as line is fed through the channel of assembly 112.

Pliers 10 and 100 can each be assembled and manufactured in a variety of different manners to achieve the goals and objectives of the present invention.

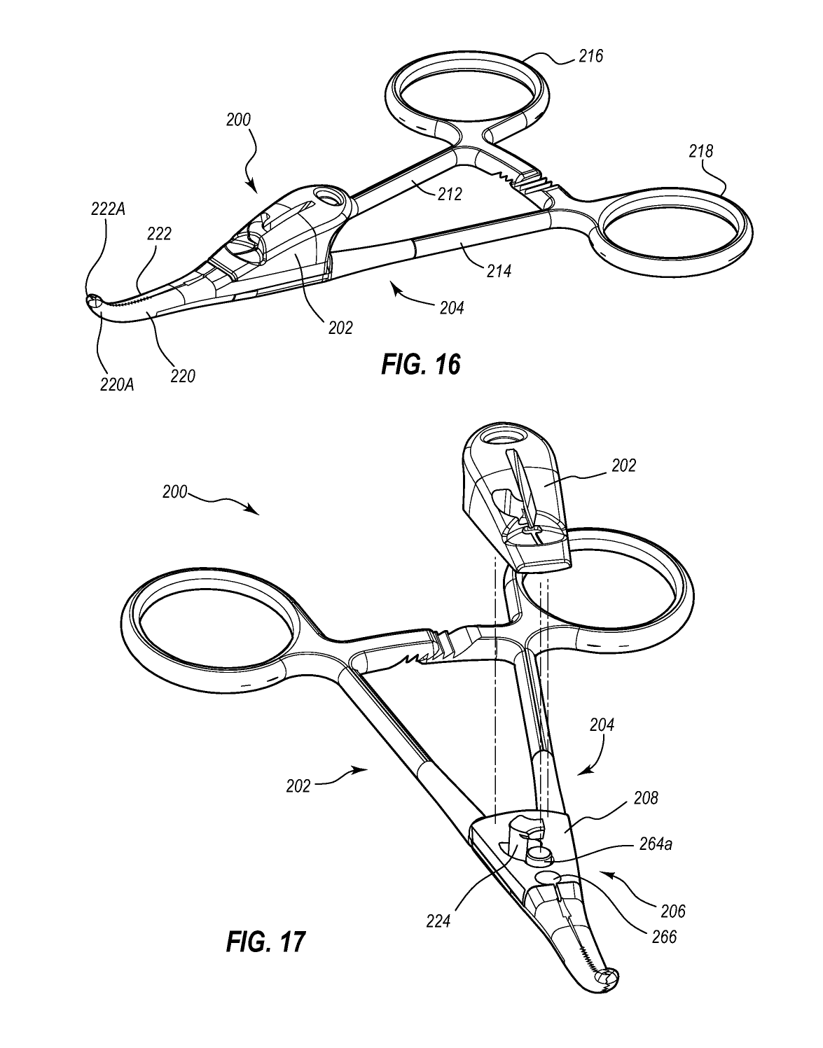

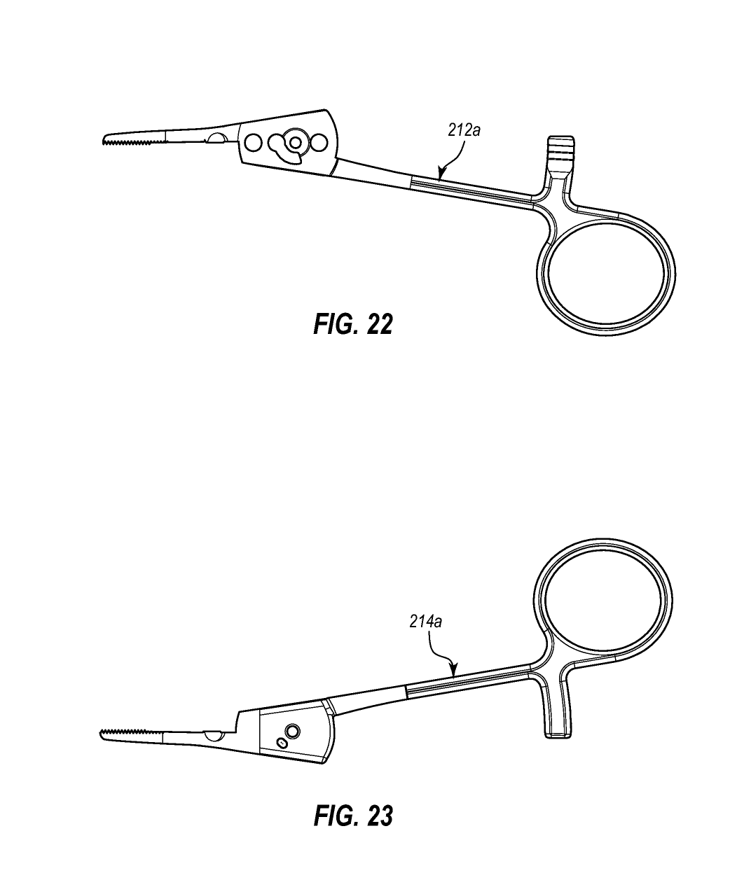

FIGS. 16-24D show yet another embodiment of fishing pliers 200 of the present invention.

As shown in FIGS. 16-18a, pliers 200 comprises first elongate member 212 pivotally coupled to second elongate member 214. Each elongate member 212, 214 comprises a respective elongate member body 212a, 214a having a handle 216, 218 at the respective proximal portion thereof, a distal tip 220, 222 at the respective distal portion thereof, and a respective intermediate section 221, 223 between the respective proximal handle and the respective distal tip thereof. Elongate members 212, 214 are capable of pivotally moving between an open position and a closed position.

Plier body 204 is comprised of first elongate member body 212a and second elongate member body 214a pivotally coupled to first elongate member body 212a.

With continued reference to FIGS. 16-18a, fishing pliers 200 are comprised of: (i) a plier body 204 (comprising body 212a and body 214a coupled together); and (ii) a platform 202 selectively mounted on plier body 204. Pliers 200 is assembled through the use of selectively attachable platform 202, which selectively mounts onto the body 204 of pliers 200, in the intermediate section 206 of plier body 204. Intermediate section 206 of plier body 204 is thus a platform receiving area for receiving platform 202 or other platforms shown in FIGS. 21A-C. In the embodiment shown in FIGS. 16-18a, platform 202 can be selectively mounted and dismounted from body 204 of pliers 200.

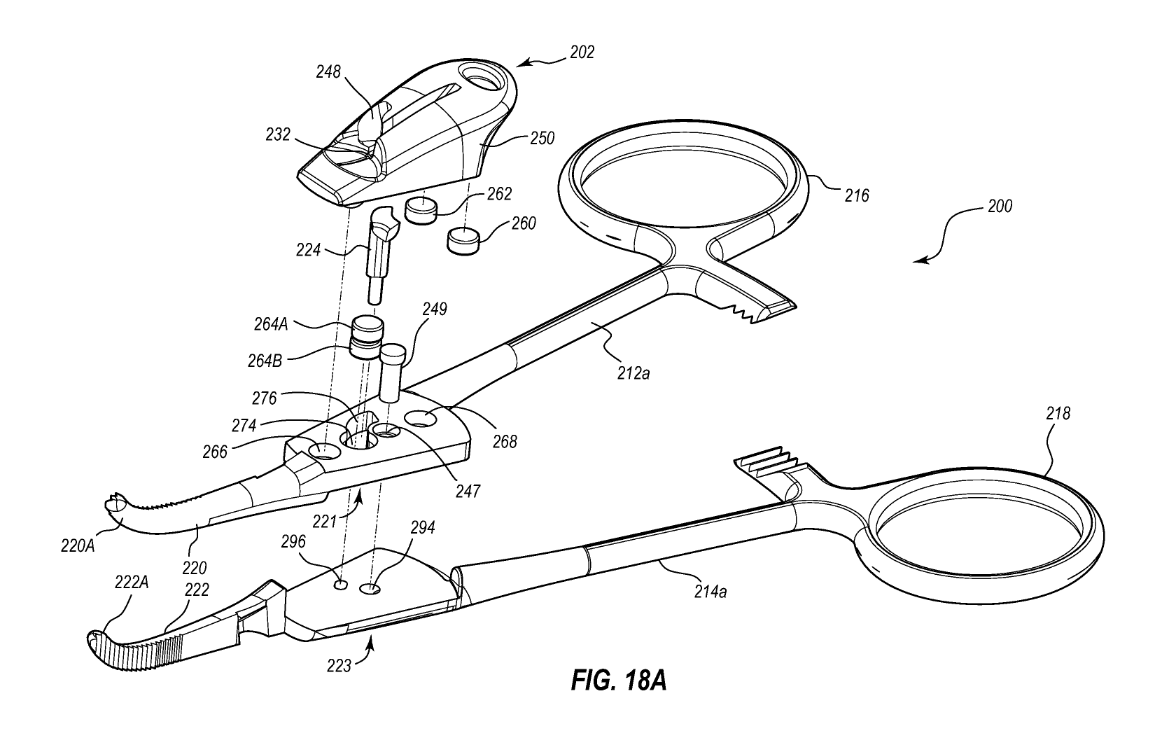

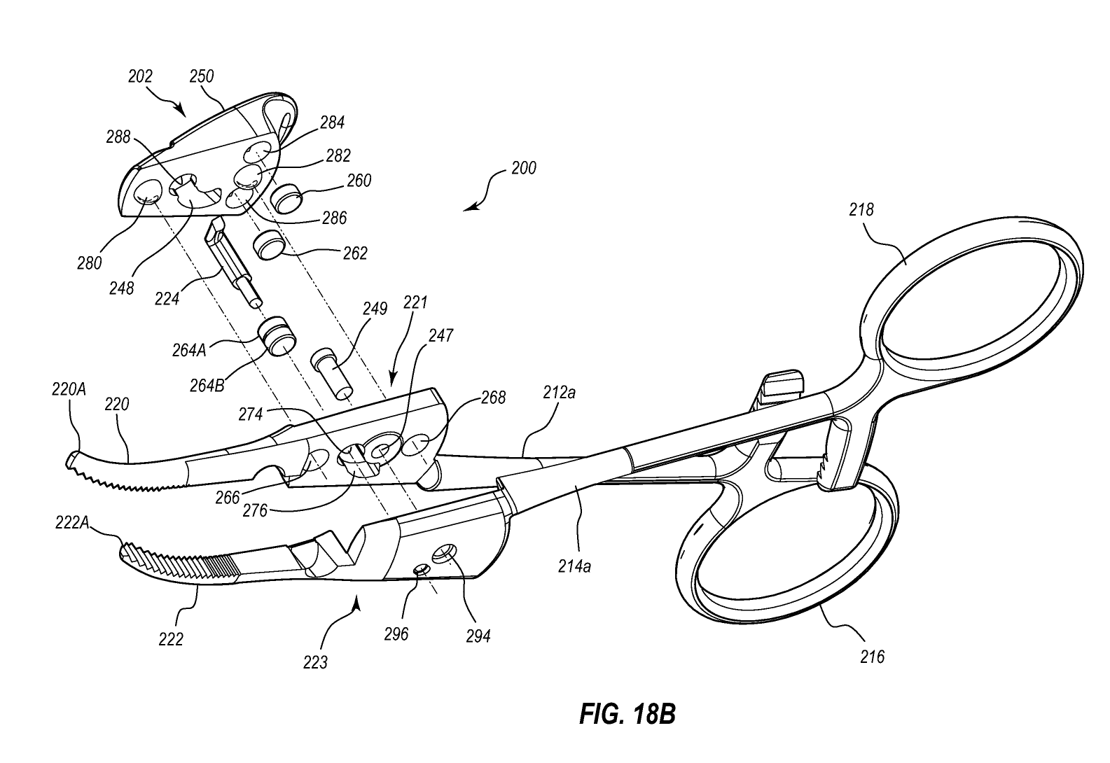

As shown in FIGS. 18A-B, the intermediate section 221 of first elongate member body 212a is configured to selectively receive modular platform 202, which is selectively mounted on intermediate section 221. The selective mounting of platform 202 enables different sizes and styles of platforms 202 to be mounted on first elongate member body 212a, such that different types and sizes of fishing line and different types and sizes of fishing lures can be connected using various platforms mounted on intermediate section 221.

As further illustrated in FIGS. 18A-B, the intermediate section 221 of first elongate member body 212a has a pivot hole 247 that receives pin 249 and the intermediate section 223 of second elongate member body 214a has an anchor hole 294 that receives pin 249 to thereby pivotally couple elongate member bodies 212a, 214a.

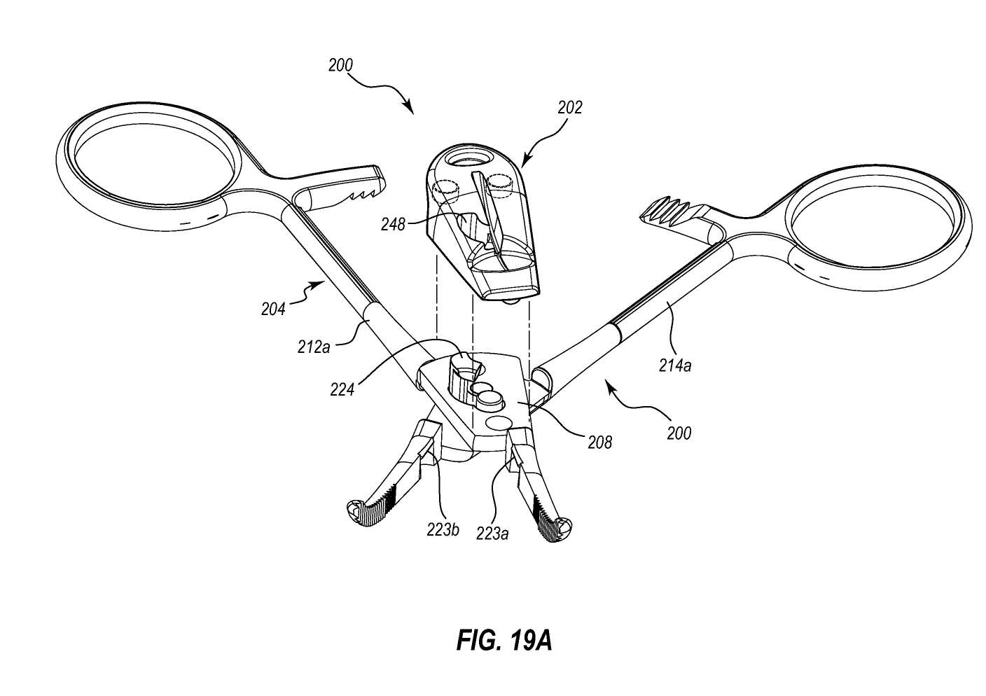

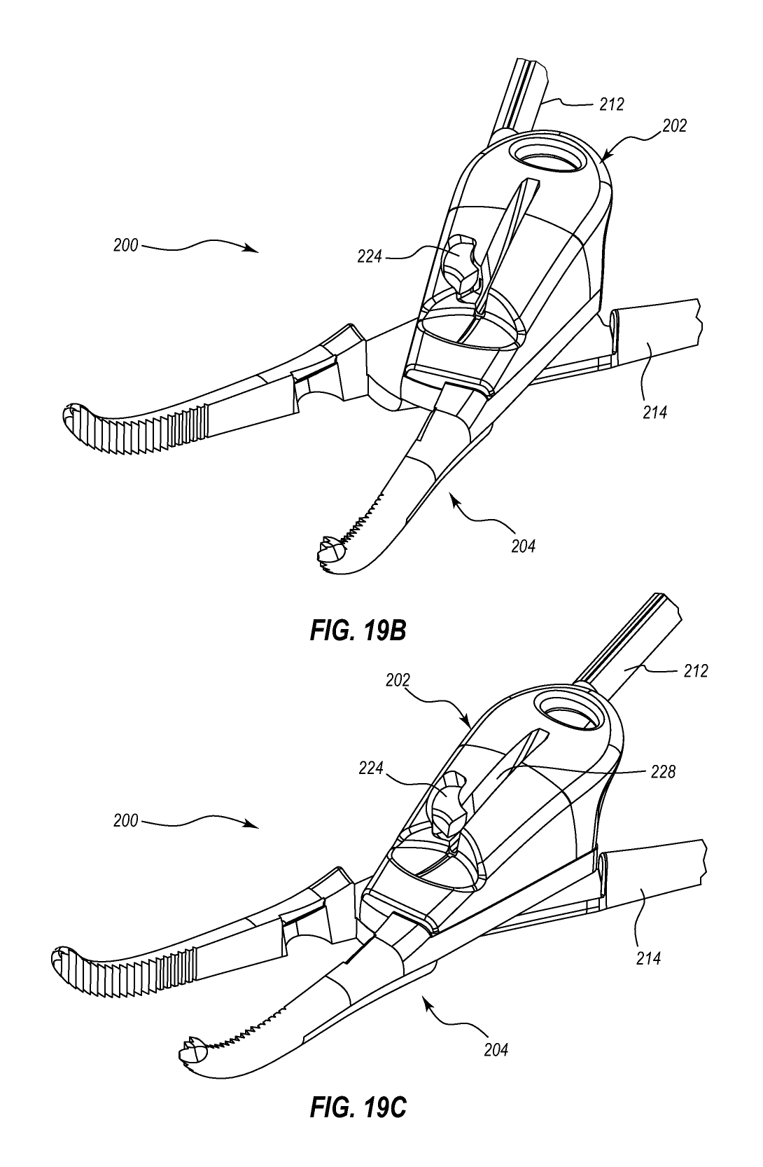

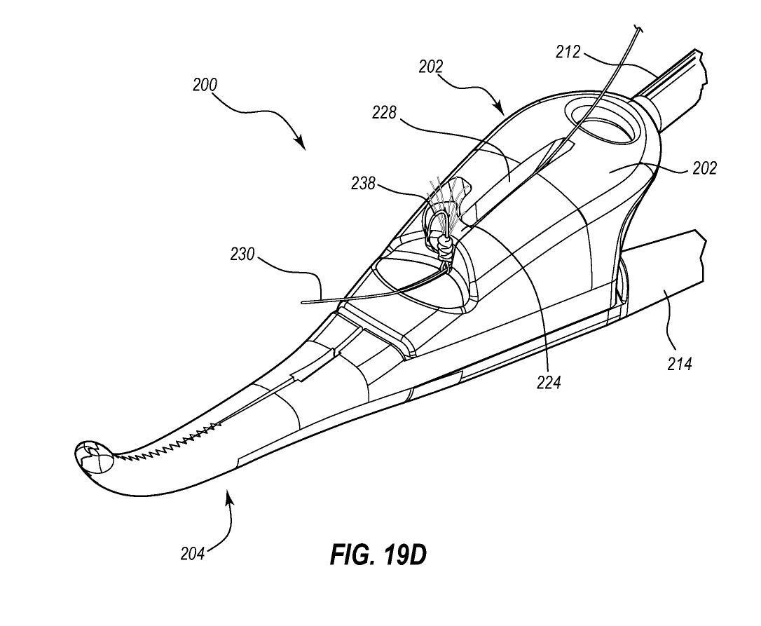

As further illustrated in FIGS. 18A-B, a magnet 264B is mounted within aperture 274 of elongate member body 212a so as to be below slot 232 of platform 202, lower magnet 264B being capable of providing a magnetic force that temporarily maintains a metallic eyelet of a lure 238 in slot 232 while line 230 is threaded through the eyelet of lure 238, as illustrated in FIG. 19D.

As further illustrated in FIGS. 18A-B, upper magnet 264a is mounted on magnet 264b in a vertically stacked arrangement to provide additional magnetic force. Once platform 202 is mounted onto elongate member body 212a, upper magnet 264a is housed within recess 288 (FIG. 18B) of body 250 of platform 202 As a result, once platform 202 is mounted onto elongate member body 212a, stacked magnets 264a-b below slot 232 of platform 202 combine to provide magnetic forces to maintain an eyelet of a lure 238 within slot 232 of platform 202 while fishing line is guided therethrough.

As further illustrated in FIGS. 18A-B, a raised arm assembly 224 is anchored within anchor hole 296 of intermediate section 223 of second elongate member body 214a and extends upwardly therefrom through a curved receiving aperture 276 of intermediate section 221 of first elongate member body 212a. Curved receiving aperture 276 enables arm 224 to move within intermediate section 221 of first elongate member body 212a when elongate members 212, 214 are pivoted with respect to each other. Raised arm 224 further fits and moves within curved hole 248 of platform 202 when platform 202 is mounted on intermediate section 221 of elongate member 212.

Aperture 276 is thus a pass-through hole through which the raised arm 224 passes. Raised arm 224 extends upwardly from the intermediate section of elongate member body 214a. Arm 224 passes through the curved pass-through aperture 276, which is shaped to allow pliers 200 to be capable of moving between an open position and a closed position and prevents the pliers 200 from opening beyond a certain point, thereby preventing the pliers 200 from opening too widely.

As further illustrated in FIGS. 18A-B, intermediate section 221 of first elongate member body 212a includes alignment holes 266, 268 for selectively receiving respective protuberances 280, 282 on the underside of body 250 of platform 202 for mounting platform 202 on intermediate section 221, e.g., in a snap fitting relationship and/or for properly orienting platform 202 with intermediate section 221. Platform 202 is further selectively mounted and maintained on intermediate section 221 of first elongate member 212 through the use of magnets 260, 262 embedded within respective recesses 284, 286 within body 250 of platform 202. In one embodiment, magnets 260, 262 selectively connect to the metallic body 204 of body 221a in the intermediate section 221 thereof. Elongate member bodies 212a, 214a may be made from stainless steel, for example. Pin 249 may be made of a higher strength steel, for example. Magnets 260, 262 can be maintained within respective recesses 284, 286, e.g., by being embedded therein and/or through an adhesive or interference fit, for example. Furthermore, when platform 202 is mounted on body 204 of pliers 200, arm 224 is extended within platform 202, further increasing the coupling of platform 202 to body 204 of pliers 200.

With continued reference to FIGS. 18A-B, when platform 202 is mounted onto the intermediate section of first elongate member body 212a, raised arm 224 moves within cured hole 248 in platform 202. Hole 248 is curved and arm 224 moves within hole 248 such that when elongate members 212, 214 are in the closed position of FIG. 19D, the raised arm raised arm 224 covers a portion of channel 228, thereby maintaining fishing line within channel 228 (FIG. 19D). Alternatively, when elongate members 212, 214 are in the open position, the raised arm 224 does not cover channel 228 (see FIG. 19B) and line 230 can be removed from channel 228, e.g., after a lure has been threaded and tied with line 230. As such, the curved shape of hole 248 enables pliers 200 to freely move between the open and closed position.

With reference again to FIG. 18a, the distal tips 220, 222 of the respective elongate members of the pliers of the present invention are substantially straight along the surfaces of the respective bodies thereof and have a slight bend at the distal tip end 220a, 222a thereof. However, in other embodiments, the slight bend at the tip end is not required.

The bodies of distal tips 220, 222 are substantially straight with little or no tapering angle along the surfaces of the bodies thereof (and do not substantially bend until reaching the tip ends 220a, 222a) in order to improve the ability to twist fishing line 230 without fishing line 230 falling off the distal tips 220, 222. The straight or substantially straight tips, e.g., tips 220, 222 make twisting the line 230 during a knot tying procedure, as shown in FIG. 7, more convenient because the line 230 is less likely to fall off the pliers, as opposed to dramatically tapering tips. Dramatically tapering tips have a surface angle that causes line to fall off during the twisting procedure. However, the straight or substantially straight tips 220, 222 make twisting the line 230 during a knot tying procedure more convenient because the line is less likely to fall off.

With reference now to FIGS. 19A-B, when platform 202 is mounted on first elongate member, arm 224 extends through curved hole 248 in platform 202. As illustrated in FIGS. 19C-D, pliers 200 can then be moved to the closed position of FIG. 19D, wherein arm 224 of the second elongate member 214 can be moved with respect to hole 248 in platform 202 and over channel 228, such that in use, when pliers 200 are closed (FIG. 19D), the fishing line 230 can travel through channel 228 and under arm 224 and then through an eyelet of a lure 238 mounted in slot 232, which is adjacent channel 228.

FIG. 19D shows pliers 200 with a fishing lure 238 in the form of a fishing fly magnetically coupled to pliers 200 within slot 232. FIG. 19D shows the first elongate member 212 receiving an eyelet of a fishing lure thereon. The eyelet of lure 238 is oriented so as to be capable of receiving fishing line 230 that is extended through channel 228. Arm 224 is oriented within platform 202 so as to create a pathway to guide the fishing line 230 within channel 228 (e.g., to the bottom of channel 228) in order to align the fishing line with the eyelet of the lure 238. In one embodiment, in order to thread the eyelet, the hole defined by the eyelet is oriented so as to be generally transverse to the channel 228. As shown in FIG. 19D, pliers 200 are closed such that arm 224 is closed over channel 228, such that line 230 will not be accidentally removed out of channel 228 when threaded into the eyelet.

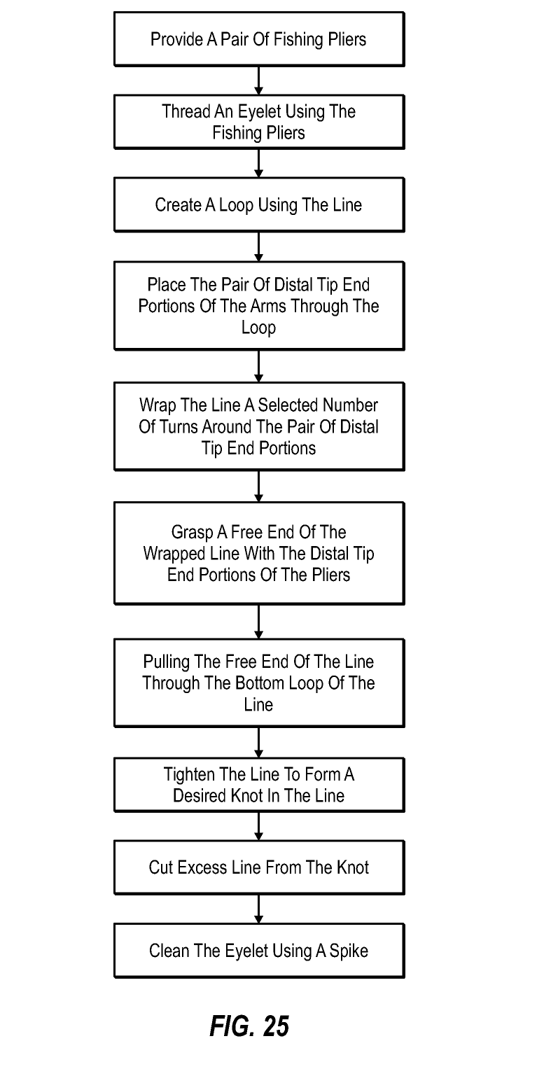

Once the line 230 is extended through the eyelet of the lure 238, the pliers can be used to form the desired fishing knot that connects lure 238 to line 230, similar or identical to the methods illustrated in FIGS. 6-11 and/or discussed with reference to FIGS. 6-11 and/or FIG. 25.

FIG. 19D shows a user threading line 230 along channel 228 of the pliers 200 and through eyelet of the lure 238 that is mounted within slot 232 of platform 202. Once pliers 200 are closed, line 230 can be fed through channel 228 and through the eyelet 232 without being accidentally moved out of channel 228.

As further shown in FIG. 19D, in the closed position, arm 224 prevents line 230 from being inadvertently moved from channel 228. Arm 224 extends generally transverse to a longitudinal axis of second elongate member 214 and extends partially out of hole 248 of modular platform 202 to maintain line 230 in channel 228 during use. In certain embodiments, line 230 can be placed in channel 228, after which arm 224 is extended over line 230 by closing pliers 200. Optionally, in certain embodiments, line 230 can be placed in channel 228 after arm 224 has already been placed within channel 228. The distal tips 220, 222 have respective cutting blades 223a, 223b (FIG. 19A) for cutting excess line from a knot.

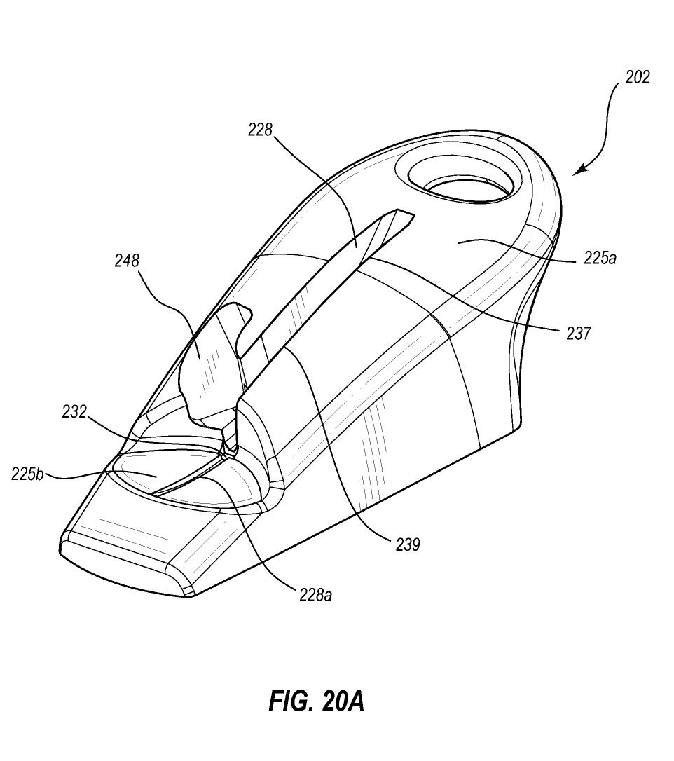

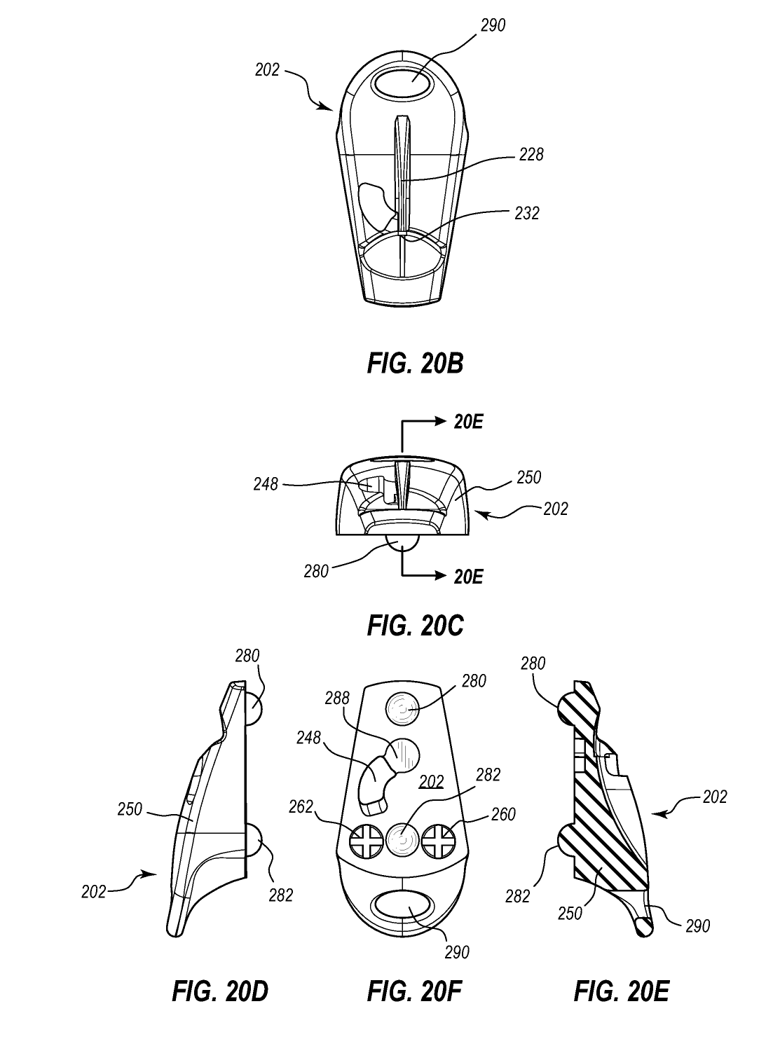

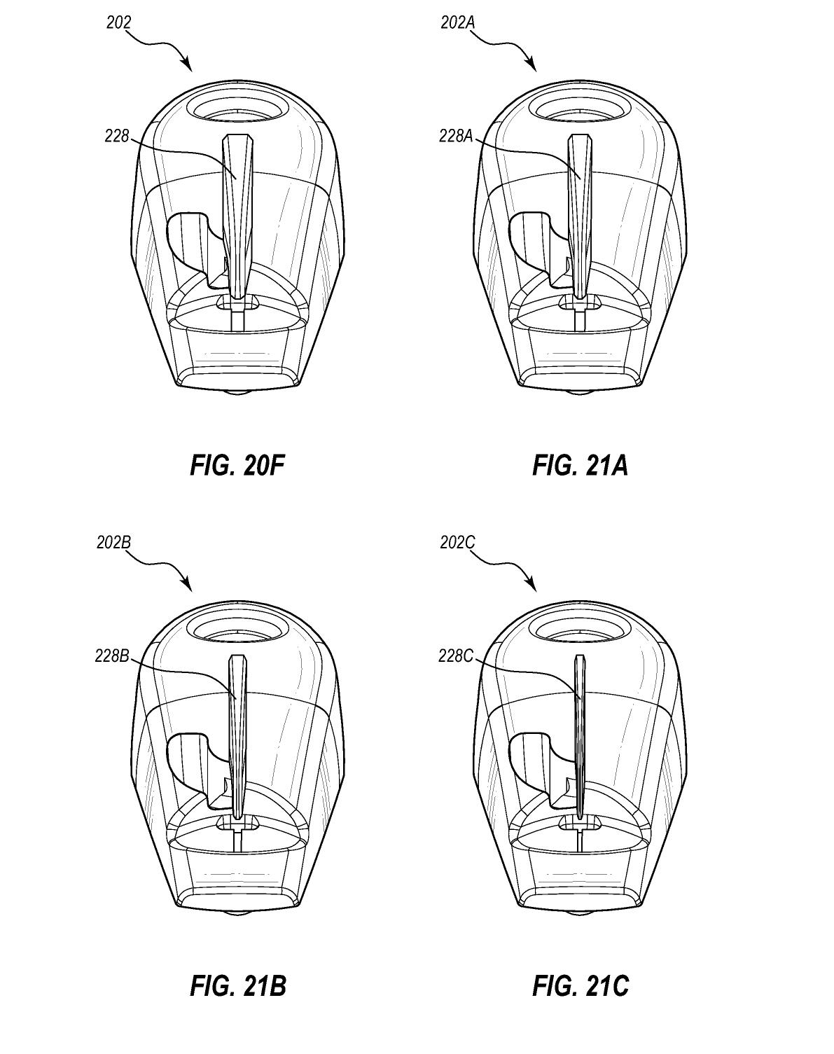

With reference to FIGS. 20A-F, selectively mountable platform 202 has a distal platform portion 225b in the form of a receiving area for receiving fishing line and a proximal raised portion 225a that is adjacent to distal platform 225b and is raised with respect to the distal platform portion 225b. Slot 232 (see FIG. 20A) is configured to receive an eyelet of a fishing lure 238 and is located below channel 228 and is situated generally transverse to channel 228. Distal platform 225b can be curved so as to receive the curling fishing line 230 that is extended thereon when a line 230 is placed through an eyelet of a lure.

As further shown in FIGS. 20A-F, modular platform 202 has, in the proximal raised platform 225a thereof, an upper channel 228 configured to receive a fishing line 330 therein. The distal platform 225b has a lower channel 228a that is adjacent upper channel 228 for receiving fishing line that has been extended through upper channel 228. Distal platform 225b further has a slot 232 therein positioned between upper channel 228 and lower channel 228a, slot 232 being generally transverse to the longitudinal axis of upper channel 228 and lower channel 228a. Slot 232 is configured to receive the eyelet of a fishing lure 238 therein, the metallic eyelet of lure 238 being attracted to the magnetic force of magnets 264A, 264B that are stacked within and/or below recess 288 (20F) within body 250 of platform 202.

FIG. 20F illustrates magnets 260, 262 within platform 202 which selectively couple platform 202 to body 204 of pliers 200. Aperture 290 can be used for hanging platform 202 or other platforms, e.g., against a wall, when not in use. For example, aperture 290 may be used to store the platform 202 on a hanging device such a lanyard or keychain, enabling a fisherman to conveniently store platform 202 when not in use.

Pliers 200 are thus configured to enable a user to conveniently move a fishing line 230 along channel 228 and into the eyelet of a fishing lure that is mounted within slot 232, which is aligned with and adjacent to channel 228 so as to enable the eyelet to conveniently receive line 230.

In one embodiment, a proximal end 237 (FIG. 20A) of the proximal channel 228 is wide, so as to readily receive a fishing line 230 while a distal end 239 of proximal channel 228 is relatively narrow (i.e., channel 228 narrows as it moves distally), so as to begin feeding a line into transverse slot 232. Thus, in one embodiment, channel 228 is wider at a proximal end and progressively narrowing to a distal end. As a result, channel 228 is configured to conveniently receive a portion of fishing line and feed it through slot 232. Channel 228 runs substantially parallel to the longitudinal axis of the elongate member 212.

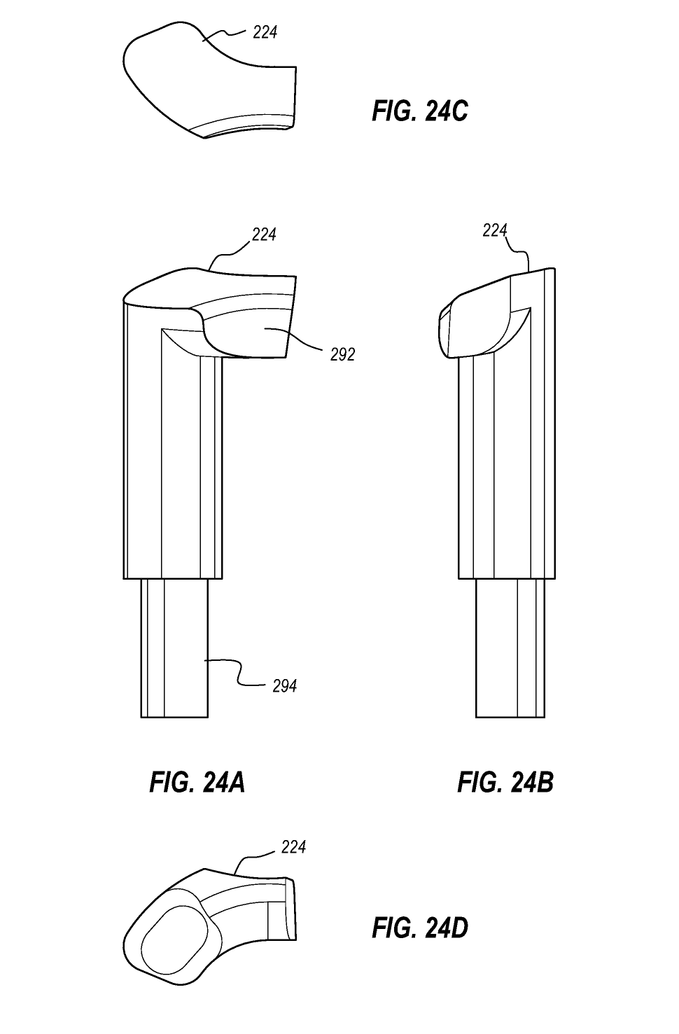

As illustrated in FIGS. 24A-D, arm 224 is comprised of a head portion 292, which fits within hole 248 and over channel 228 and which extends upwardly from intermediate section 226 of second elongate member body 214a through the use of a post 294 mounted within the intermediate section 226 of second elongate member body 214a.

Pliers 200 are very versatile and can accomplish a number of different tasks required by the fisherman to connect a fishing hook or fly or other lure to a fishing line, which is often a cumbersome and time consuming process, which becomes more difficult with age or disability. Pliers 200 are used to initially thread the line 230 onto the lure 238, and then to form a knot in the line and cut away excess line from the knot once the hook is threaded.

Magnets 264a-b are positioned on elongate member 212 adjacent slot 232 such that the magnetic force of the magnet retains the eyelet of the lure therein such that line 230 can be readily passed through the eyelet. Elongate members 212, 214 may comprise a material such as a stainless steel, for example. In one embodiment, platform 202 is comprised of a plastic, neoprene, rubber, resinous or other synthetic material and is manufactured as a separate snap in piece for convenient manufacturing and/or for enabling the changing of the size of the channel 228 for receiving different line diameters, etc. Platform 202 may be comprised of ZYTEL, for example, such as ZYTEL ST 801. In another embodiment, platform 202 is comprised of a metallic material, such as stainless steel.

An example of a method of threading and tying a fishing lure using the fishing pliers 200 (or 10 or 100) is demonstrated in FIG. 25. FIG. 25 represents a method of threading and tying a fishing lure. This method enables a fisherman to thread an eyelet and tie a fishing knot in one continuous process. The method comprises (1) providing a pair of fishing pliers, e.g., pliers 200 (or pliers 10 or 100); (2) threading an eyelet with a portion of fishing line using the fishing pliers; (3) creating a loop using a portion of line passed through the eyelet and a portion of line not passed through the eyelet; (4) placing the distal tip end portions of the first and second arms of the pliers through the loop; (5) wrapping the portion of line a selected number of turns around the pair of distal tip end portions (thereby twisting the line using the pliers); (6) grasping a free end of the line with the distal tip end portions of the fishing device; (7) pulling the free end of the portion of line through the bottom loop of the portion of line; (8) tightening the portion of line to form a desired knot in the line; and (9) cutting excess line from the knot. The method can further include cleaning the eyelet using a spike.

Conveniently, this method of threading the eyelet, tying a knot on the eyelet, and removing excess line from the eyelet can be performed while keeping pliers 200 in the same hand, e.g., the right hand or the left hand. When threading the eyelet, it is preferable to orient the eyelet within slot 232 such that line 230 will readily move from channel 228 into the eyelet, e.g., by placing the eyelet so that the hole of the eyelet is oriented so as to readily receive the line 230 extending through channel 228.

Since fishing line stored on a circular shaped object generally has a natural curve to it, it is generally more convenient to hold the line 230 with the curved portion facing upward before moving the line along channel 228, such that the line 230 feeds conveniently into the eyelet, e.g., with approximately an inch or an inch and a half or two inches, for example, in front of the fingers of the user prior to threading within channel 228.

FIGS. 19D and 6-11 further illustrate a process for threading, tying, and trimming line 230 or line 30, the processes of which are the same or similar. After pushing the line 230 through the channel 228 and the eyelet (such as illustrated in FIG. 19D), e.g., when approximately two inches, for example, of line 230 extend past the eyelet, the user can grasp both ends of the line (see FIG. 6), e.g., with approximately one inch, for example, of free line extending from the fingers, then open the pliers 200 to release the line 230 from channel 228. In one embodiment, the nose of pliers 200 is then placed into the resulting loop (see FIG. 6) so that the concave portions of distal ends 220, 222 of pliers is on top of the lure, after which approximately five or six twists of line can be made (see FIG. 7), after which the free end of line 230 can be grasped by the pliers 200 (see FIG. 8) and pulled through the lower loop (see loop 70 in FIG. 8) and tightened to form a fisherman's knot (see FIGS. 8-10). The excess line can then be cut off with blades 223a, 223b (see FIG. 11). The entire method of threading the eyelet, tying a knot on the eyelet, and removing excess line from the eyelet can be performed using pliers 200 and while keeping pliers in the same hand, e.g., the right hand or the left hand, throughout the entire method, making threading, tying, and trimming very convenient.

In one embodiment, after pushing the line 230 through the channel 228 and the eyelet (such as illustrated in FIG. 19D), e.g., when approximately two inches of line 230 extend past the eyelet, the user can grasp both ends of the line by first grasping the non-free end and then by continuing the movement to grasp the free end, thereby forming a loop, although a variety of approaches can be employed.

Although the embodiment of platform 202 described herein utilizes magnets 260, 262 to be mounted to the body 250 of elongate member 212, the principles described herein are not limited to magnets for connecting platform 202 to elongate member body 212a. Snap-fitting methods, for example, may alternatively be employed for selectively mounting platform 202 to body 212a of elongate member 212.

Yet another embodiment of the pliers 200 may also include a spike that is located on second elongate member 214 and corresponding aperture located on the first elongate member 212 such that the spike fits into the corresponding aperture of the first arm when pliers 200 are in the closed position. The spike can be used to clean the eyelet of a fishing lure.

Accordingly, the present invention includes fishing pliers 200 that can be used to assist a user in threading and tying a fishing lure. The pliers 200 are very beneficial to a user, particularly a user in the outdoors, because the pliers 200 may be used to assist the user in quickly and efficiently threading a lure. Moreover, pliers 200 are not only capable of assisting in the threading process, but are also capable of tying a knot and cutting off excess line. These benefits can all be accomplished using a single tool which greatly maximizes compartmentalization and efficiency. Using pliers 200, a user need only carry a single tool to perform a wide variety of functions.

A kit of the present invention comprises fishing pliers 200 suitable for threading and tying a fishing lure, the pliers 200 comprising: (i) a pair of opposing first and second elongate member bodies 212a, 214a pivotally connected at a pivot, the elongate member bodies 212a, 214a capable of moving between an open position and a closed position, each comprising a proximal handle portion, a distal tip end portion, and an intermediate section in-between; (ii) at least two modular platforms 202, 202a, i.e., a first modular platform 202 and an interchangeable second modular platform 202a, the at least two modular platforms 202, 202a each capable of being mounted, one at a time, on the intermediate section of the first elongate member body 212a, the at least two modular platforms 202, 202a each having: (A) a channel, the channel running parallel to the longitudinal axis of the first elongate member, the channel configured to receive a portion of line, the channel having a wider opening at one end and progressively narrowing to an opening at a base terminal end, the channel of the interchangeable second modular platform 202a differing in size from the channel of the first modular platform 202; and (B) a slot (the slot located at the channel terminal end, the slot situated transverse to the channel terminal end, the slot configured to: (1) receive an eyelet, and (2) orient the eyelet to receive the portion of line passing through the channel); and (iii) a magnet, the magnet located adjacent to the slot, the magnet capable of securing the eyelet in the slot.

Platform 202 is an example of a threading system mounted on a plier body 204. The threading system comprises: (i) a platform selectively mounted on the plier body 204, the platform 202 having a channel for guiding fishing line into the eyelet of a fishing lure; and (ii) a magnet positioned adjacent the platform 202 for selectively maintaining the eyelet of a fishing lure on the platform 202. Other examples of threading systems may be employed which may be configured to thread a variety of different types of eyelets, e.g., needle eyelets or other eyelets that receive a thread, line or cable. Platform 202 is a modular platform on which the channel extends, the modular platform being selectively mounted onto a body of the first elongate member.

For convenience, the invention further comprising one or more replacement platforms having a different channel size, each of which are interchangeable with the first platform 202. Platform 202 can be removed from the first elongate member body without being obstructed by the arm when the first and second elongate member bodies are in the open position—for replacement with a second platform that is interchangeable with the first platform and has a different sized channel.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. Fishing pliers that enable a user to conveniently extend fishing line into an eyelet of a fishing lure, the fishing pliers comprising:
a first elongate member; and
a second elongate member pivotally coupled to the first elongate member, each elongate member having a proximal handle portion and a distal tip portion and an intermediate section therebetween;
wherein the first elongate member is configured to receive fishing line in a channel thereof; and wherein the first elongate member receives an eyelet of a fishing lure thereon such that when fishing line is moved along the channel of the first elongate member, the fishing line is oriented so as to conveniently enter the eyelet of the fishing lure, thereby enabling the user to conveniently extend fishing line into the eyelet of a fishing lure.

2. Fishing pliers as recited in claim 1, wherein the first elongate member has a platform having the channel, the channel configured to guide the line into an eyelet of a fishing lure that is mounted on the first elongate member.

3. Fishing pliers as recited in claim 1, wherein the first elongate member comprises a platform on an intermediate portion of the elongate member, the channel extending along the platform.

4. Fishing pliers as recited in claim 1, wherein the channel is configured to guide the fishing line into an eyelet of a fishing lure that is mounted on the first elongate member,
and wherein the second elongate member has an arm that fits within a cavity of the first elongate member when the two elongate members are in a closed position and which covers the channel so as to prevent line from being inadvertently removed from the channel.

5. Fishing pliers as recited in claim 1, wherein the first elongate member further has a slot that is generally transverse to the longitudinal axis of the channel, the slot configured to receive an eyelet of a fishing lure.

6. Fishing pliers as recited in claim 1, further comprising a magnet mounted on the first elongate member, the magnet generating a force that selectively maintains an eyelet of a lure adjacent the channel with the eyelet ready to receive fishing line therethrough.

7. Fishing pliers as recited in claim 1, wherein the pliers is configured such that once a fishing line is threaded through an eyelet of a lure, the pliers can be placed within a loop formed in the fishing line, after which line can be twisted using the pliers, after which an end of the line can be pulled through the loop using the pliers to thereby form a knot in the line.

8. Fishing pliers, comprising:
a plier body comprising a first elongate member body pivotally coupled to a second elongate member body, each elongate member body having a proximal handle portion and a distal tip portion and an intermediate section there between; and
a threading system on the plier body, the threading system configured to receive an eyelet of a fishing lure and to guide fishing line into an eyelet of a fishing lure when the line is moved along the threading system, such that when fishing line is passed through a channel of the threading system, the fishing line enters the eyelet of the fishing lure.

9. Fishing pliers as recited in claim 8, wherein the threading system comprises (i) a platform on the plier body; and (ii) a magnet positioned adjacent the platform for selectively maintaining the eyelet of a fishing lure on the fishing pliers.

10. Fishing pliers as recited in claim 9, wherein the platform has a slot configured to receive the eyelet of the fishing lure.

11. Fishing pliers as recited in claim 10, wherein a longitudinal axis of the slot is transverse to a longitudinal axis of the channel.

12. Fishing pliers as recited in claim 9, wherein, the second elongate member body has an arm coupled thereto, the arm configured to selectively cover the channel, so as to prevent line from being inadvertently removed from the channel.

13. Fishing pliers as recited in claim 8, wherein the pliers is configured such that once a fishing line is threaded through an eyelet of a lure, the pliers can be placed within a loop formed in the fishing line, after which line can be twisted using the pliers, after which an end of the line can be pulled through the loop using the pliers to thereby form a knot in the line, wherein the pliers comprise cutting surfaces such that excess line can then be cut away from the knot.

14. Fishing pliers as recited in claim 8, wherein the pliers is configured such that a method for threading a line through a fishing lure and tying the line onto the fishing lure using the fishing pliers provided in claim 8 comprises:
mounting an eyelet of a lure on the pliers adjacent the channel;
guiding a fishing line though the channel and through the eyelet;
creating a loop using the line;
placing respective distal ends of the first and second elongate members through the loop;
twisting a portion of line using the pliers;
grasping a free end of the fishing line with the distal ends of the pliers;
pulling the free end of the fishing line through a bottom loop of the fishing line;
tightening the fishing line to form a knot in the line; and
cutting excess fishing line from the knot.

15. Fishing pliers, comprising:
a plier body capable of moving between an open position and a closed position, the plier body comprising a body of a first elongate member pivotally coupled to a body of the second elongate member, each elongate member of the first and second elongate members having a proximal handle portion and a distal tip portion and an intermediate section there between;
a platform on the plier body, the platform configured to receive an eyelet of a fishing lure, the platform configured to guide fishing line into an eyelet of a fishing lure, such that when fishing line is passed along the platform, the fishing line enters an eyelet of a fishing lure, thereby enabling the user to conveniently extend fishing line into an eyelet of a fishing lure; and
a magnet positioned on the first elongate member body, the magnet generating a force that selectively maintains an eyelet of a lure in a desired location adjacent to the platform with the eyelet ready to receive fishing line therethrough.

16. Fishing pliers as recited in claim 15, wherein the platform has a channel through which fishing line can be guided into an eyelet of a fishing lure, and further comprising: an arm located on an intermediate section of the second elongate member body, the arm configured to cover a top portion of the channel when the elongate member bodies are in the closed position, whereby the arm prevents a portion of the line passing through the channel from escaping from the channel when the elongate member bodies are in the closed position.

17. Fishing pliers as recited in claim 15, wherein the pliers is configured such that a method for threading a line through a fishing lure and tying the line onto the fishing lure using the fishing pliers of claim 15 comprises:
mounting an eyelet of a lure on the pliers adjacent the channel;
guiding a fishing line though the channel and through the eyelet;
creating a loop using the line;
placing respective distal ends of the first and second elongate members through the loop;
twisting the line using the pliers;
grasping a free end of the fishing line with the distal ends of the pliers;
pulling the free end of the fishing line through a bottom loop of the fishing line;
tightening the fishing line to form a knot in the line; and
cutting excess fishing line from the knot.

18. Fishing pliers as recited in claim 15, wherein the platform has a slot configured to receive the eyelet of the fishing lure.

19. Fishing pliers as recited in claim 18, wherein a longitudinal axis of the slot is transverse to a longitudinal axis of the channel.

20. Fishing pliers as recited in claim 15, wherein the magnet is positioned within the first elongate member.
